(19) United States
(12) Patent Application Publication
(10) Pub. No.: US 2025/0303707 A1
(43) Pub. Date: Oct. 2, 2025

(54) LIQUID EJECTING APPARATUS AND METHOD OF DRIVING LIQUID EJECTING APPARATUS

(71) Applicant: SEIKO EPSON CORPORATION, Tokyo (JP)

(72) Inventors: Yuki WATANABE, MATSUMOTO-SHI (JP); Eiji YOTSUYA, MATSUMOTO-SHI (JP); Akinori TANIUCHI, MATSUMOTO-SHI (JP); Shoichiro YOKOO, ATSUGI-SHI (JP); Yoichiro KONDO, CHINO-SHI (JP); Shunsuke WATANABE, MATSUMOTO-SHI (JP); Toshimichi YAMADA, CHINO-SHI (JP)

(21) Appl. No.: 19/089,312

(22) Filed: Mar. 25, 2025

(30) Foreign Application Priority Data
Mar. 28, 2024 (JP) 2024-053889

(51) Int. Cl. B41J 2/045

(52) U.S. Cl. CPC B41J 2/04588; B41J 2/04541; B41J 2/04573; B41J 2/04581; B41J 2/04596

(57) ABSTRACT

A liquid ejecting apparatus includes: a first nozzle, a first pressure chamber, and a first drive element; a first drive signal generating circuit that generates a first drive signal to be supplied to the first drive element when a droplet is to be ejected; and a second drive signal generating circuit that generates a second drive signal to be supplied to the first drive element. The first drive signal has a first pulse and a first starting electrical potential-maintained element that maintains a first electrical potential from the start of a single driving cycle to the start of the first pulse. The second drive signal has: a second pulse; and a second starting electrical potential-maintained element that maintains a second electrical potential from the start of the single driving cycle to the start of the second pulse. The first electrical potential is different from the second electrical potential.

The present application is based on, and claims priority from JP Application Serial Number 2024-053889, filed Mar. 28, 2024, the disclosure of which is hereby incorporated by reference herein in its entirety.

### BACKGROUND

### 1. Technical Field

The present disclosure relates to a liquid ejecting apparatus and a method of driving the liquid ejecting apparatus.

### 2. Related Art

A liquid ejecting apparatus that ejects liquid such as ink onto a medium such as a printing sheet has been proposed.

A liquid ejecting apparatus described in JP-A-2005-88582 includes a drive signal generator that generates a drive signal, a drive pulse selector that selectively combines a plurality of drive pulses included in the drive signal, and a drive element that ejects a droplet from a nozzle based on the selected drive pulses. In the apparatus, a pulse corresponding to an image to be printed is selected from among a plurality of types of pulses included in the drive signal, and the amount of a droplet to be ejected from the nozzle is switched.

The drive signal maintains a common electrical potential for a time period other than the pulses. When the shape of each pulse is designed so as to satisfy an ejection amount and an ejection speed that are required for the pulses included in the drive signal while the common electrical potential is fixed, the degree of freedom in design is limited. Therefore, for example, it is difficult to set the amount of a droplet to be ejected to a desired amount, and the correction of the amount of the droplet to be ejected is not sufficient.

### SUMMARY

According to an aspect of the present disclosure, a liquid ejecting apparatus includes: a liquid ejecting head including a first ejection section including a first nozzle from which liquid is ejected, a first pressure chamber communicating with the first nozzle, and a first drive element that is driven to change a volume of the first pressure chamber in accordance with a drive signal; a first drive signal generating circuit that generates a first drive signal having a first pulse to be supplied to the first drive element when a droplet in a first amount is to be ejected from the first nozzle; and a second drive signal generating circuit that generates a second drive signal having a second pulse to be supplied to the first drive element and different from the first pulse. The first drive signal has a first starting electrical potential-maintained element that maintains a first electrical potential from start of a single driving cycle to start of the first pulse. The second drive signal has a second starting electrical potential-maintained element that maintains a second electrical potential from the start of the single driving cycle to start of the second pulse. The first electrical potential is different from the second electrical potential.

According to another aspect of the present disclosure, a method of driving a liquid ejecting apparatus including a liquid ejecting head including a first ejection section including a first nozzle from which liquid is ejected, a first pressure chamber communicating with the first nozzle, and a first drive element that is driven to change a volume of the first pressure chamber in accordance with a drive signal includes generating a first drive signal having a first pulse to be supplied to the first drive element when a droplet in a first amount is to be ejected from the first nozzle; and generating a second drive signal having a second pulse to be supplied to the first drive element and different from the first pulse. In the generation of the first drive signal and the second drive signal, a first electrical potential of a first starting electrical potential-maintained element which is included in the first drive signal and is from start of a single driving cycle to start of the first pulse is set to be different from a second electrical potential of a second starting electrical potential-maintained element which is included in the second drive signal and is from the start of the single driving cycle to start of the second pulse.

### BRIEF DESCRIPTION OF THE DRAWINGS

FIG. 1 is a schematic diagram illustrating an example of a configuration of a liquid ejecting apparatus according to a first embodiment.

FIG. 2 is a diagram illustrating an electrical configuration of the liquid ejecting apparatus according to the first embodiment.

FIG. 3 is a bottom view of a liquid ejecting head illustrated in FIG. 2.

FIG. 4 is a cross-sectional view illustrating a portion of a head chip illustrated in FIG. 3.

FIG. 5 is a diagram for explaining a drive signal supplied to each of first nozzle rows illustrated in FIG. 3.

FIG. 6 is a diagram for explaining a drive signal supplied to each of second nozzle rows illustrated in FIG. 3.

FIG. 7 is a diagram for explaining a drive signal supplied to each of third nozzle rows illustrated in FIG. 3.

FIGS. 8A to 8C are diagrams illustrating an example of a case where driving cycles are continuous.

FIG. 9 is a diagram for explaining the supply of a drive signal.

FIG. 10 is a diagram for explaining the supply of the drive signal.

FIGS. 11A and 11B are diagrams for explaining the correction of a drive signal in the related art.

FIG. 12 is a diagram illustrating a relationship between a driving cycle and the amount of liquid to be ejected according to a drive signal in the related art.

FIG. 13 is a diagram illustrating a relationship between a peak value and the amount of liquid to be ejected for each frequency according to the drive signal in the related art.

FIGS. 14A to 14C are diagrams for explaining frequency characteristics.

FIG. 15 is a diagram for explaining an effect of the frequency characteristics on the amount of liquid to be ejected.

FIGS. 16A to 16C are diagrams for explaining the correction of a large dot drive signal according to the present embodiment.

FIG. 17 is a diagram illustrating a relationship between a driving cycle and the amount of liquid to be ejected in the correction of the large dot drive signal according to the present embodiment.

FIG. 18 is a diagram illustrating an ejection speed when an intermediate electrical potential is changed when a driving cycle changes to a next driving cycle.

FIG. 19 is a diagram illustrating the ejection speed when a range of change in an electrical potential when a driving cycle changes to a next driving cycle is changed.

FIG. 20 is a diagram illustrating deviations from a landing position when the range of change in the electrical potential is changed while a transport speed is 80 m/min.

FIG. 21 is a diagram illustrating deviations from the landing position when the range of change in the electrical potential is changed while the transport speed is 40 m/min.

FIG. 22 is a diagram illustrating a drive signal in a first modification.

### DESCRIPTION OF EMBODIMENTS

Hereinafter, preferred embodiments according to the present disclosure will be described with reference to the attached drawings. In the drawings, the size and scale of each portion or section are different from the actual size and scale of each portion or section as appropriate, and some portions or sections are schematically illustrated to facilitate understanding. The scope of the present disclosure is not limited to these embodiments unless otherwise stated to limit the disclosure in the following description.

The following description will be made with an X axis, a Y axis, and a Z axis that intersect each other as appropriate. In the following description, one direction along the X axis is an X1 direction, and a direction opposite to the X1 direction is an X2 direction. Similarly, directions opposite to each other along the Y axis are a Y1 direction and a Y2 direction. Directions opposite to each other along the Z axis are a Z1 direction and a Z2 direction. Typically, the Z axis is a vertical axis, and the Z2 direction corresponds to a downward direction in a vertical direction. The Z axis may be rather than the vertical axis. The X axis, the Y axis, and the Z axis are typically perpendicular to each other, but are not limited thereto. For example, the X axis, the Y axis, and the Z axis may intersect each other at an angle of 80° or greater and 100° or less. In addition, in the present specification, “equal” has a meaning including a manufacturing error and an assembly error in addition to a case of being strictly equal.

### A. First Embodiment

### A1: Overall Configuration of Liquid Ejecting Apparatus 100

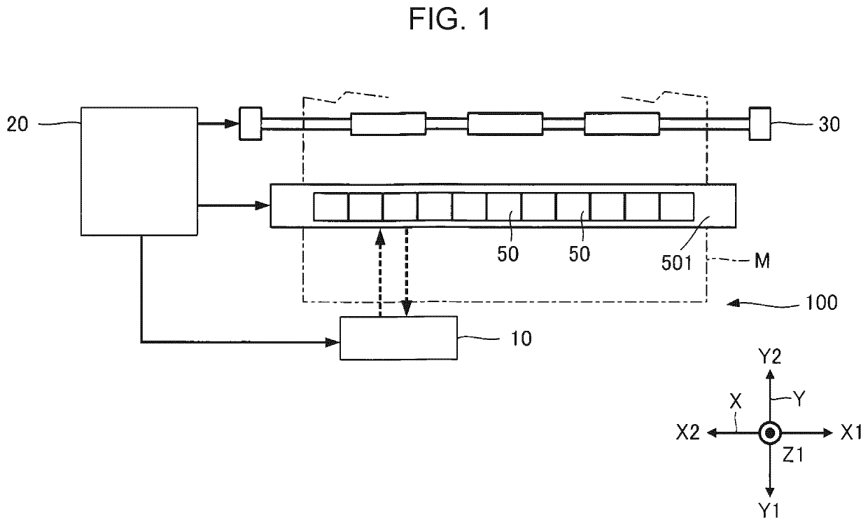

FIG. 1 is a schematic diagram illustrating an example of a configuration of a liquid ejecting apparatus 100 according to a first embodiment. The liquid ejecting apparatus 100 is an ink jet type printing apparatus that ejects liquid, such as ink, as a droplet onto a medium M. The medium M is, for example, a printing sheet. The medium M is not limited to the printing sheet and may be, for example, a printing target of any material such as a resin film or fabric.

As illustrated in FIG. 1, the liquid ejecting apparatus 100 includes a liquid container 10, a control unit 20, a transport mechanism 30, and liquid ejecting heads 50.

The liquid container 10 stores liquid. Specific aspects of the liquid container 10 include, for example, a cartridge that can be attached to and detached from the liquid ejecting apparatus 100, a bag-shaped liquid pack formed of a flexible film, and a liquid tank that can be refilled with liquid. A type of the liquid stored in the liquid container 10 is optional.

The control unit 20 controls an operation of each element of the liquid ejecting apparatus 100. The control unit 20 includes, for example, one or a plurality of processing circuits such as a central processing unit (CPU) or a field-programmable gate array (FPGA), and one or a plurality of storage circuits such as a semiconductor memory.

The transport mechanism 30 transports the medium M in the Y1 direction under control by the control unit 20. The transport mechanism 30 includes, for example, an elongated transport roller extending along the X axis and a motor that rotates the transport roller. Note that the transport mechanism 30 is not limited to the configuration in which the transport roller is used, and for example, may have a configuration in which a drum or an endless belt that transports the medium M in a state in which the medium M is attracted to an outer circumferential surface of the drum or the endless belt by an electrostatic force or the like is used.

The plurality of liquid ejecting heads 50 are mounted in a carriage 501. The plurality of liquid ejecting heads 50 are provided so as to be distributed over the entire range of the medium M in the direction along the X axis. Each of the liquid ejecting heads 50 ejects liquid supplied from the liquid container 10 onto the medium M from each of a plurality of nozzles under control by the control unit 20 based on image data Img. The ejection is performed in parallel with the transport of the medium M by the transport mechanism 30, and thus an image corresponding to the image data Img is formed by droplets on a surface of the medium M.

### A2: Electrical Configuration of Liquid Ejecting Apparatus 100

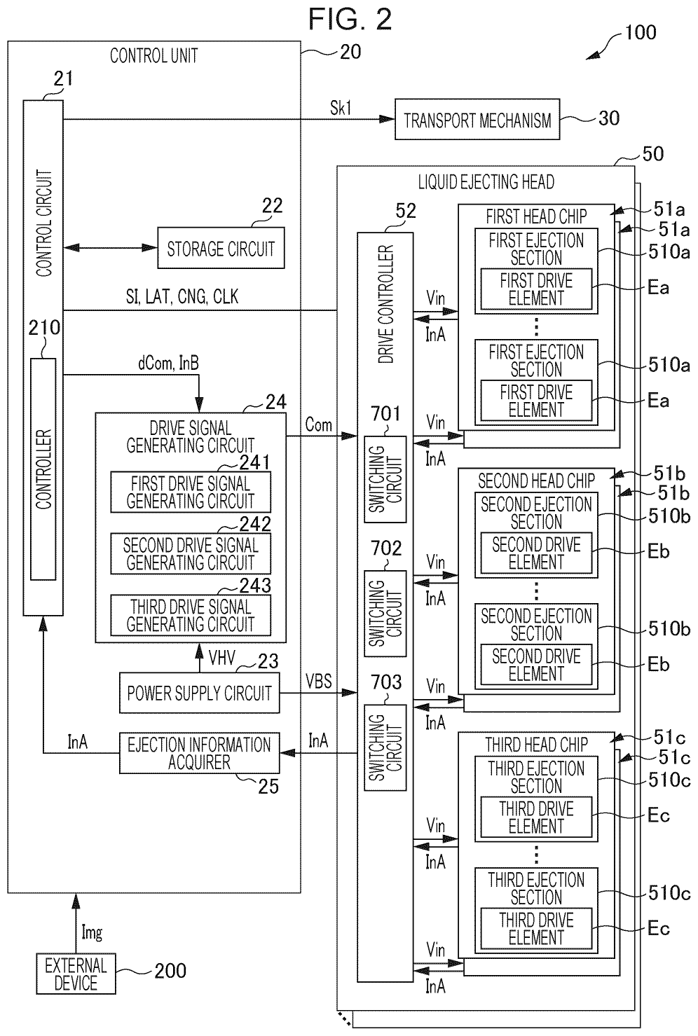

FIG. 2 is a diagram illustrating an electrical configuration of the liquid ejecting apparatus 100 according to the first embodiment. As illustrated in FIG. 2, each of the liquid ejecting heads 50 includes a plurality of head chips 51 and a drive controller 52.

In the present embodiment, six head chips 51 are provided as the plurality of head chips 51. Specifically, two first head chips 51a, two second head chips 51b, and two third head chips 51c are provided.

Each of the head chips 51 includes a plurality of ejection sections 510. Specifically, each of the first head chips 51a includes a plurality of first ejection sections 510a. Each of the first ejection sections 510a includes a first drive element Ea. Each of the second head chips 51b includes a plurality of second ejection sections 510b. Each of the second ejection sections 510b includes a second drive element Eb. Each of the third head chips 51c includes a plurality of third ejection sections 510c. Each of the third ejection sections 510c includes a third drive element Ec. Each of the ejection sections 510 has a nozzle N from which liquid is ejected, which will be described later.

The drive controller 52 switches whether or not to supply a drive signal Com output from the control unit 20 as a supply signal Vin to each of the plurality of ejection sections 510 included in the head chips 51 under control by the control unit 20. The drive controller 52 acquires, from each of the head chips 51, ejection amount information InA regarding the amounts of droplets to be ejected from the nozzles N and transmits the ejection amount information InA to the control unit 20.

The control unit 20 includes a control circuit 21, a storage circuit 22, a power supply circuit 23, a drive signal generating circuit 24, and an ejection amount information acquirer 25.

The control circuit 21 has a function of controlling an operation of each of sections of the liquid ejecting apparatus 100 and a function of processing various data. The control circuit 21 includes, for example, a processor such as one or more central processing units (CPUs). The control circuit 21 may include a programmable logic device such as a field-programmable gate array (FPGA) instead of or in addition to the one or more CPUs. When the control circuit 21 includes a plurality of processors, the plurality of processors may be mounted on different substrates or the like.

The control circuit 21 generates a control signal Sk1, a print data signal SI, a waveform specifying signal dCom, a latch signal LAT, a change signal CNG, and a clock signal CLK by executing the program, as signals for controlling the operation of each of the sections of the liquid ejecting apparatus 100.

The control signal Sk1 is a signal for controlling the driving of the transport mechanism 30. The print data signal SI is a digital signal for specifying operation states of the drive elements E. The latch signal LAT is used together with the print data signal SI, and is a timing signal that defines a timing at which the liquid is ejected from each of the nozzles N of the head chips 51.

The control circuit 21 includes a controller 210. The controller 210 generates drive signal information InB for specifying a waveform of the drive signal Com based on the ejection amount information InA, and transmits the drive signal information InB to the drive signal generating circuit 24.

The storage circuit 22 stores various programs to be executed by the control circuit 21 and various data such as the image data Img to be processed by the control circuit 21. The storage circuit 22 includes, for example, one or both of a semiconductor memory that is a volatile memory such as a random-access memory (RAM) and a semiconductor memory that is a non-volatile memory such as a read-only memory (ROM), an electrically erasable programmable read-only memory (EEPROM), or a programmable ROM (PROM). The image data Img is supplied from an external device 200 such as a personal computer or a digital camera. The storage circuit 22 may be configured as a portion of the control circuit 21.

The power supply circuit 23 receives power supplied from a commercial power supply (not illustrated) and generates various predetermined electrical potentials. The generated various electrical potentials are appropriately supplied to the sections of the liquid ejecting apparatus 100. For example, the power supply circuit 23 generates a power supply electrical potential VHV and an offset electrical potential VBS. The offset electrical potential VBS is supplied to the liquid ejecting heads 50. Furthermore, the power supply electrical potential VHV is supplied to the drive signal generating circuit 24.

The drive signal generating circuit 24 is a circuit that repeatedly generates a drive signal Com for driving each of the drive elements E included in the ejection sections 510. Specifically, the drive signal generating circuit 24 includes, for example, a digital-to-analog (DA) conversion circuit and an amplifier circuit. In the drive signal generating circuit 24, the DA conversion circuit converts the waveform specifying signal dCom from the control circuit 21 from a digital signal to an analog signal. The amplifier circuit amplifies the analog signal using the power supply electrical potential VHV from the power supply circuit 23, thereby generating the drive signal Com. A signal with a waveform which is among waveforms included in the drive signal Com and is actually supplied to the drive elements E is the above-described supply signal Vin. The waveform specifying signal dCom is a digital signal for defining the waveform of the drive signal Com.

The drive signal generating circuit 24 includes, for example, a first drive signal generating circuit 241 that generates a first drive signal ComAa, a second drive signal generating circuit 242 that generates a second drive signal ComC, and a third drive signal generating circuit 243 that generates a third drive signal ComAb. The drive signal generating circuit 24 also includes a drive signal generating circuit that generates a fourth drive signal ComAc, a drive signal generating circuit that generates a fifth drive signal ComBa, a drive signal generating circuit that generates a sixth drive signal ComBb, and a drive signal generating circuit that generates a seventh drive signal ComBc, which are not illustrated. The first drive signal ComAa, the second drive signal ComC, the third drive signal ComAb, the fourth drive signal ComAc, the fifth drive signal ComBa, the sixth drive signal ComBb, and the seventh drive signal ComBc will be described later.

### A3: Arrangement of Plurality of Head Chips 51

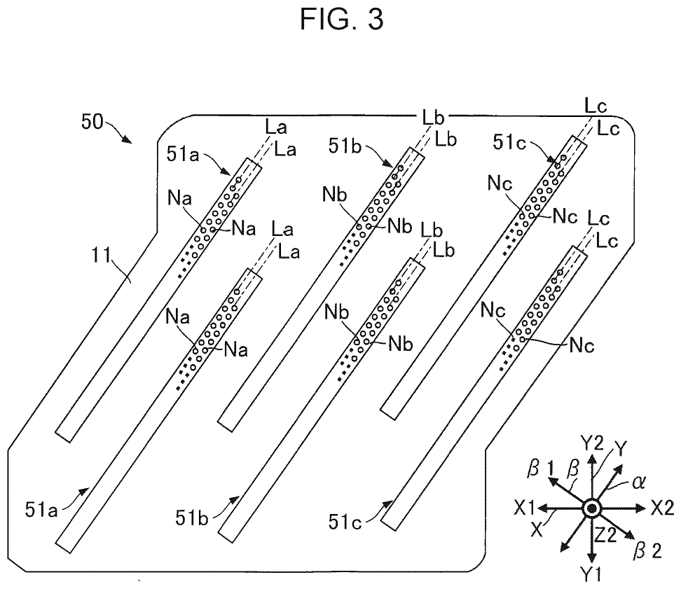

FIG. 3 is a bottom view of the liquid ejecting head 50 illustrated in FIG. 2. As described above, the liquid ejecting head 50 includes the six head chips 51 separated from each other. Each of the head chips 51 has an elongated shape extending along an a axis intersecting the X axis and the Y axis as viewed in the Z1 direction.

In the present embodiment, each of the two head chips 51 located on the left side in FIG. 3 among the six head chips 51 is referred to as a “first head chip 51a”. Each of the two head chips 51 located in a central portion in FIG. 3 is referred to as a “second head chip 51b”. Each of the two head chips 51 located on the right side in FIG. 3 is referred to as a “third head chip 51c”.

Each of the first head chips 51a includes a plurality of first nozzles Na. The plurality of first nozzles Na are divided into two first nozzle rows La and arranged along the longitudinal direction of the first head chip 51a. Similarly, each of the second head chips 51b includes a plurality of second nozzles Nb. The plurality of second nozzles Nb are divided into two second nozzle rows Lb and arranged along the longitudinal direction of the second head chip 51b. Each of the third head chips 51c includes a plurality of third nozzles Nc. The plurality of third nozzles Nc are divided into two third nozzle rows Lc and arranged along the longitudinal direction of the third head chip 51c. Each of the nozzle rows L intersects the X axis and the Y axis and is a set of a plurality of nozzles N arranged in a straight line.

The planar shape of each of the plurality of nozzles Nis, for example, a circular shape, and the plurality of nozzles N are formed to have the same opening area. The nozzles N belonging to each of the nozzle rows L are arranged at equal intervals along a β axis orthogonal to the α axis.

### A4: Configuration of Portion of Each Head Chip 51

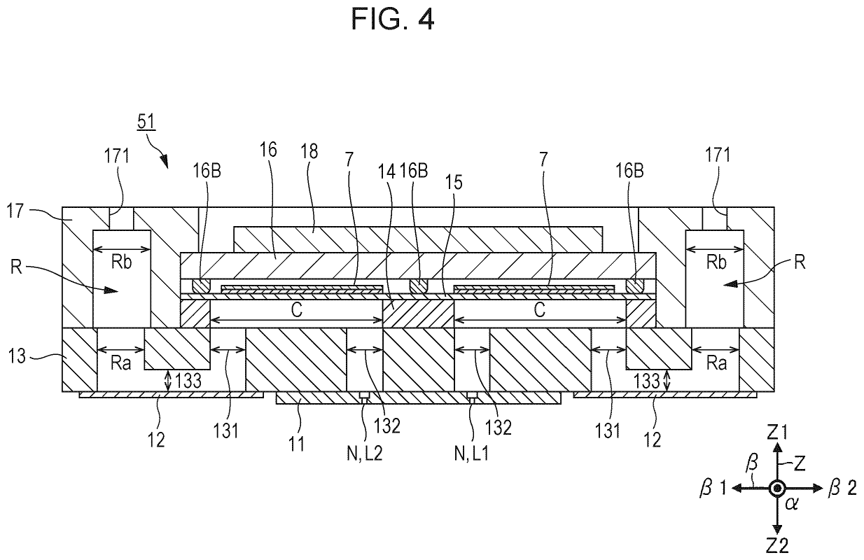

FIG. 4 is a cross-sectional view illustrating a portion of the head chip 51 illustrated in FIG. 3. As illustrated in FIG. 4, the head chip 51 includes a nozzle plate 11, a vibration absorbing body 12, a flow path substrate 13, a pressure chamber substrate 14, a vibration plate 15, a wiring substrate 16, a housing portion 17, and a drive circuit 18. Each of the nozzle plate 11, the vibration absorbing body 12, the flow path substrate 13, the pressure chamber substrate 14, the vibration plate 15, the wiring substrate 16, and the housing portion 17 is a plate-like member elongated in the direction along the Y axis. The nozzle plate 11, the flow path substrate 13, the pressure chamber substrate 14, the vibration plate 15, and the wiring substrate 16 are arranged in this order in the Z1 direction.

The nozzle plate 11 is a plate-like member in which the plurality of nozzles N are formed. Each of the plurality of nozzles N is a through-hole through which the liquid passes. The liquid is ejected from the nozzles N by the vibration of the vibration plate 15. The nozzle plate 11 is bonded to the flow path substrate 13 by, for example, an adhesive.

A flow path for supplying the liquid to the plurality of nozzles N is formed in the flow path substrate 13. Specifically, a space Ra, a plurality of supply flow paths 131, a plurality of communication flow paths 132, and a supply liquid chamber 133 are formed in the flow path substrate 13. The space Ra is an elongated opening extending in a direction along the α axis in plan view as viewed in the direction along the Z axis. Each of the supply flow paths 131 and the communication flow paths 132 is a through-hole formed for each of the nozzles N. The supply liquid chamber 133 is an elongated space extending in the direction along the α axis over the plurality of nozzles N, and the space Ra communicates with the plurality of supply flow paths 131 via the supply liquid chamber 133. Each of the plurality of communication flow paths 132 overlaps one nozzle N corresponding to the communication flow path 132 in plan view. The pressure chamber substrate 14 is bonded to the flow path substrate 13 by, for example, an adhesive.

The pressure chamber substrate 14 is provided with a plurality of pressure chambers C. Each of the pressure chambers C is formed for a respective one of the nozzles N and is an elongated space extending in the direction along the β axis in plan view. The plurality of pressure chambers C are arranged in the direction along the α axis. The pressure chambers C are spaces located between the flow path substrate 13 and the vibration plate 15. The pressure chambers C communicate with the nozzles N via the communication flow paths 132 and communicate with the space Ra via the supply flow paths 131 and the supply liquid chamber 133.

Each of the nozzle plate 11, the flow path substrate 13, and the pressure chamber substrate 14 is manufactured by processing a silicon single crystal substrate using, for example, dry etching, wet etching, or the like. However, other known methods may be appropriately used to manufacture the nozzle plate 11, the flow path substrate 13, and the pressure chamber substrate 14.

The vibration plate 15 is disposed on a surface of the pressure chamber substrate 14 facing in the Z1 direction. The vibration plate 15 is a plate-like member that can elastically vibrate.

The plurality of drive elements E corresponding to the nozzles N are disposed on a surface of the vibration plate 15 facing the Z1 direction. Each of the drive elements E has an elongated shape extending in the direction along the β axis in plan view. The plurality of drive elements E correspond to the plurality of pressure chambers C and are arranged in the direction along the α axis. The drive elements E are driven to change the volumes of the pressure chambers C in accordance with the supply signal Vin generated from the drive signal Com. That is, each of the drive elements E is deformed by the application of a voltage. When the vibration plate 15 vibrates in conjunction with the deformation, the pressure in the pressure chambers C fluctuates and thus the liquid is ejected from the nozzles N.

The housing portion 17 is a case for storing the liquid to be supplied to the plurality of pressure chambers C. As illustrated in FIG. 4, a space Rb is formed in the housing portion 17. The space Rb of the housing portion 17 and the space Ra of the flow path substrate 13 communicate with each other. A space formed by the space Ra and the space Rb functions as a liquid storage chamber R which is a reservoir for storing the liquid to be supplied to the plurality of pressure chambers C. The liquid is supplied to the liquid storage chamber R through an inlet 171 formed in the housing portion 17. The liquid in the liquid storage chamber R is supplied to the pressure chambers C through the supply liquid chamber 133 and each of the supply flow paths 131.

The vibration absorbing body 12 is a flexible film forming a wall surface of the liquid storage chamber R. The vibration absorbing body 12 is a compliance substrate which reduces a fluctuation in the pressure applied to the liquid in the liquid storage chamber R.

The wiring substrate 16 is a plate-like member on which wiring for electrically coupling the drive circuit 18 and the plurality of drive elements E is formed. The wiring substrate 16 is, for example, a rigid substrate. On the wiring substrate 16, wiring is formed, which electrically couples the drive circuit 18 mounted on a surface facing the Z1 direction and a plurality of bumps 16B necessary for driving the drive elements E and present on a surface facing the Z2 direction. The drive circuit 18 forms a portion of the drive controller 52 described above, and includes an integrated circuit (IC) chip that outputs the offset electrical potential VBS and a supply signal Vin based on a drive signal Com for driving each of the drive elements E. A flexible wiring substrate (not illustrated) coupled to the control unit 20 is coupled to the wiring substrate 16.

The wiring substrate 16 may be, for example, a flexible substrate such as a flexible flat cable (FFC), or may be a flexible printed circuit (FPC), a chip on film (COF), or the like in which the drive circuit 18 is mounted on the wiring substrate 16.

In the head chip 51, each of the ejection sections 510 described above includes a nozzle N, a pressure chamber C, and a drive element E. In the present embodiment, one ejection section 510 is formed by a nozzle N, a pressure chamber C, a supply flow path 131, a communication flow path 132, and a portion of the vibration plate 15 corresponding to a drive element E.

The pressure chamber C and the drive element E included in each of the first ejection sections 510a included in each of the first nozzle rows La are a “first pressure chamber Ca” and a “first drive element Ea”. The pressure chamber C and the drive element E included in each of the second ejection sections 510b included in each of the second nozzle rows Lb are a “second pressure chamber Cb” and a “second drive element Eb”. The pressure chamber C and the drive element E included in each of the third ejection sections 510c included in each of the third nozzle rows Lc are a “third pressure chamber Cc” and a “third drive element Ec”.

The configuration of each of the head chips 51 is not limited to the example illustrated in FIG. 4. Each of the head chips 51 may have, for example, a circulation flow path for circulating the liquid.

### A5: Drive Signal Com

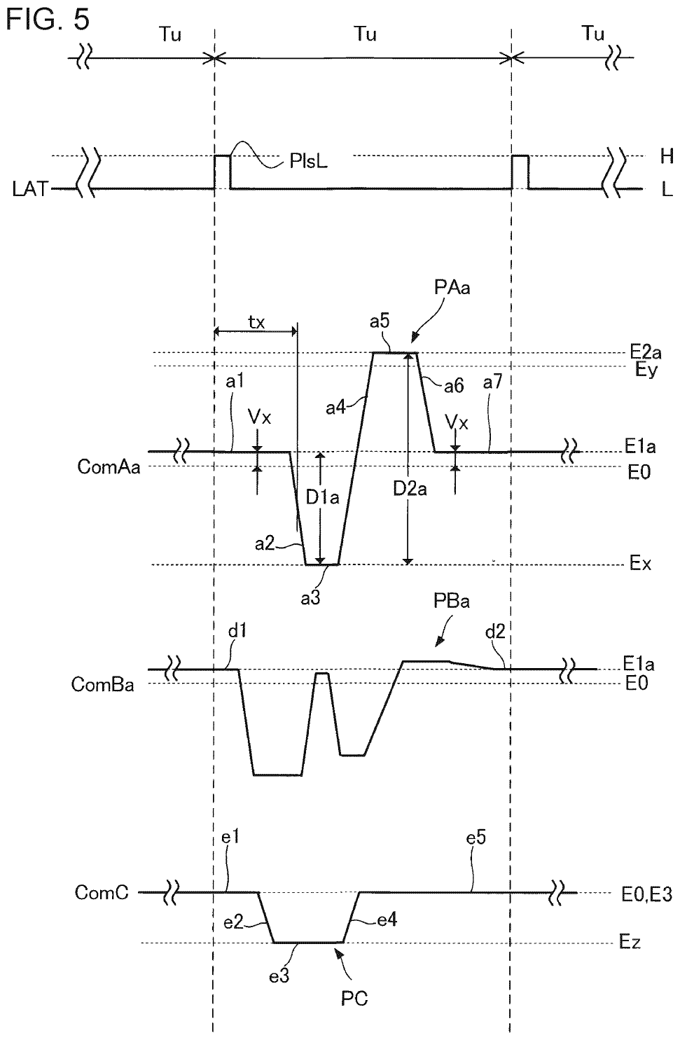

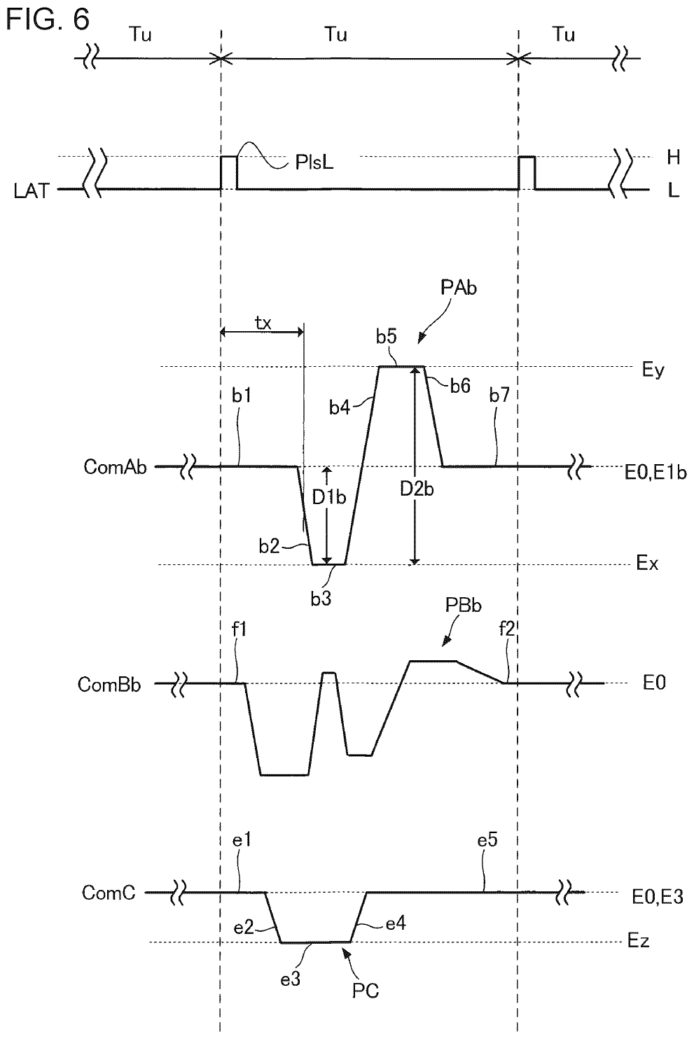

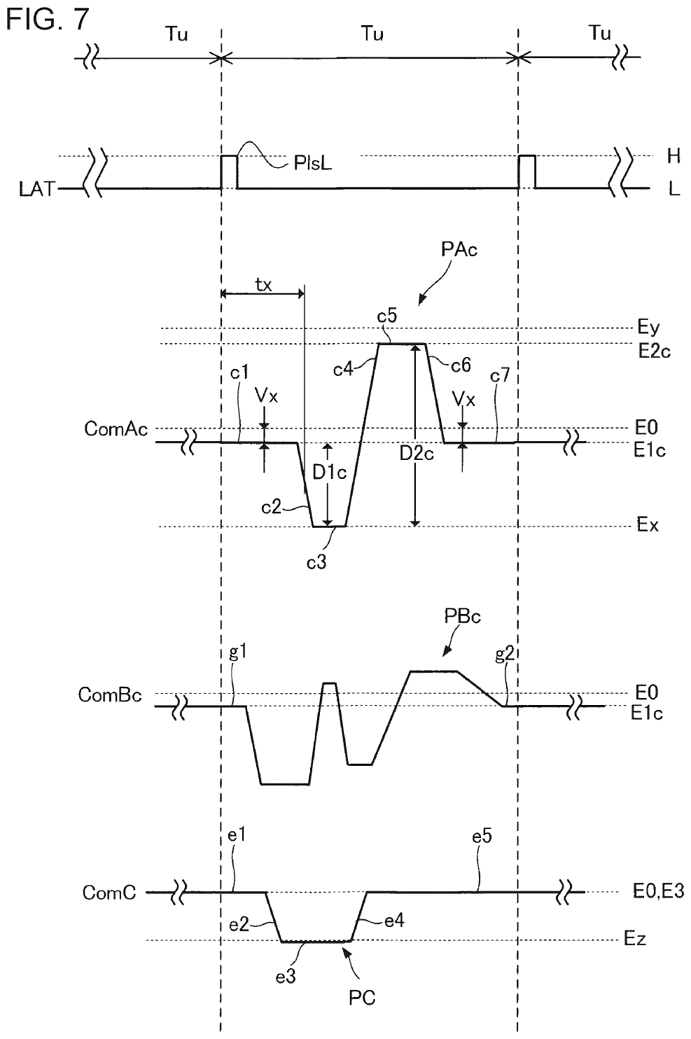

FIG. 5 is a diagram for explaining a drive signal Com for generating a supply signal Vin to be supplied to each of the first nozzle rows La illustrated in FIG. 3. FIG. 6 is a diagram for explaining a drive signal Com for generating a supply signal Vin to be supplied to each of the second nozzle rows Lb illustrated in FIG. 3. FIG. 7 is a diagram for explaining a drive signal Com for generating a supply signal Vin to be supplied to each of the third nozzle rows Lc illustrated in FIG. 3.

The latch signal LAT illustrated in FIGS. 5 to 7 includes pulses PlsL for defining a driving cycle Tu. The driving cycle Tu corresponds to a printing cycle in which dots of droplets from the nozzles N are formed on the medium M. The driving cycle Tu is defined as, for example, a time period from the rising edge of the pulse PlsL to the rising edge of the next pulse PlsL. A specific length of the driving cycle Tu is not particularly limited.

As described above, the drive signal generating circuit 24 illustrated in FIG. 2 generates the drive signal Com. The drive signal Com includes, for example, the first drive signal ComAa, the third drive signal ComAb, the fourth drive signal ComAc, the fifth drive signal ComBa, the sixth drive signal ComBb, the seventh drive signal ComBc, and the second drive signal ComC.

As illustrated in FIG. 5, one of the first drive signal ComAa, the fifth drive signal ComBa, and the second drive signal ComC is supplied as a supply signal Vin from the drive controller 52 to one of electrodes of each of the first drive elements Ea belonging to the first nozzle rows La in a single driving cycle Tu. The offset electrical potential VBS is supplied to the other of the electrodes of each of the first drive elements Ea. Although not illustrated in detail, the drive controller 52 illustrated in FIG. 2 includes a switching circuit 701. Although not illustrated in detail, the switching circuit 701 is coupled to a signal line for transmitting the first drive signal ComAa, a signal line for transmitting the fifth drive signal ComBa, a signal line for transmitting the second drive signal ComC, a signal line for transmitting a print data signal SI1 corresponding to the first nozzle row La, a signal line for transmitting the clock signal CLK, and a signal line for transmitting the latch signal LAT. The switching circuit 701 selects one of the first drive signal ComAa, the fifth drive signal ComBa, and the second drive signal ComC based on the clock signal SCK, the print data signal SI1, and the latch signal LAT, generates a supply signal Vin corresponding to each of the first drive elements Ea, and outputs the supply signal Vin to wiring coupled to the one of the electrodes of each of the plurality of first drive elements Ea.

As illustrated in FIG. 6, one of the third drive signal ComAb, the sixth drive signal ComBb, and the second drive signal ComC is supplied as a supply signal Vin from the drive controller 52 to one of electrodes of each of the second drive elements Eb belonging to the second nozzle rows Lb in the single driving cycle Tu. The offset electrical potential VBS is supplied to the other of the electrodes of each of the second drive elements Eb. Although not illustrated in detail, the drive controller 52 illustrated in FIG. 2 includes a switching circuit 702. Although not illustrated in detail, the switching circuit 702 is coupled to a signal line for transmitting the third drive signal ComAb, a signal line for transmitting the sixth drive signal ComBb, the signal line for transmitting the second drive signal ComC, a signal line for transmitting a print data signal SI2 corresponding to the second nozzle rows Lb, the signal line for transmitting the clock signal CLK, and the signal line for transmitting the latch signal LAT. The switching circuit 702 selects one of the third drive signal ComAb, the sixth drive signal ComBb, and the second drive signal ComC based on the clock signal SCK, the print data signal SI2, and the latch signal LAT, generates a supply signal Vin corresponding to each of the second drive elements Eb, and outputs the supply signal Vin to wiring coupled to the one of the electrodes of each of the plurality of second drive elements Eb.

As illustrated in FIG. 7, one of the fourth drive signal ComAc, the seventh drive signal ComBc, and the second drive signal ComC is supplied as a supply signal Vin from the drive controller 52 to one of electrodes of each of the third drive elements Ec belonging to the third nozzle rows Lc in a single driving cycle Tu. The offset electrical potential VBS is supplied to the other of the electrodes of each of the third drive elements Ec. Although not illustrated in detail, the drive controller 52 illustrated in FIG. 2 includes a switching circuit 703. Although not illustrated in detail, the switching circuit 703 is coupled to a signal line for transmitting the fourth drive signal ComAc, a signal line for transmitting the seventh drive signal ComBc, the signal line for transmitting the second drive signal ComC, a signal line for transmitting a print data signal SI3 corresponding to the third nozzle rows Lc, the signal line for transmitting the clock signal CLK, and the signal line for transmitting the latch signal LAT. The switching circuit 703 selects one of the fourth drive signal ComAc, the seventh drive signal ComBc, and the second drive signal ComC based on the clock signal SCK, the print data signal SI3, and the latch signal LAT, generates a supply signal Vin corresponding to each of the third drive elements Ec, and outputs the supply signal Vin to wiring coupled to the one of the electrodes of each of the plurality of third drive elements Ec.

Each of the first drive signal ComAa illustrated in FIG. 5, the third drive signal ComAb illustrated in FIG. 6, and the fourth drive signal ComAc illustrated in FIG. 7 is a signal for forming a large dot which is a “droplet in a first amount”. Even when the plurality of head chips 51 attempt to eject identical droplets with the same drive signal Com, the amounts of the droplets ejected from the nozzles N may differ for each of the head chips 51 due to a manufacturing error and an assembly error. In order to reduce the difference, the drive signal Com supplied to each of the head chips 51, particularly, the signal for the large dot is adjusted.

For example, the first drive signal ComAa is generated according to the average of amounts of liquid to be ejected from the two first head chips 51a. Similarly, the third drive signal ComAb is generated according to the average of amounts of liquid to be ejected from the two second head chips 51b. The fourth drive signal ComAc is generated according to the average of amounts of liquid to be ejected from the two third head chips 51c. The first drive signal ComAa, the third drive signal ComAb, and the fourth drive signal ComAc are generated such that a difference in the amount of ejected liquid between the first head chips 51a, the second head chips 51b, and the third head chips 51c is reduced.

Each of the fifth drive signal ComBa, the sixth drive signal ComBb, and the seventh drive signal ComBc is a signal for ejecting a small dot which is smaller than the large dot. In the same manner as described above, the fifth drive signal ComBa is generated according to the average of amounts of liquid to be ejected from the two first head chips 51a. Similarly, the sixth drive signal ComBb is generated according to the average of amounts of liquid to be ejected from the two second head chips 51b. The seventh drive signal ComBc is generated according to the average of amounts of liquid to be ejected from the two third head chips 51c. The fifth drive signal ComBa, the sixth drive signal ComBb, and the seventh drive signal ComBc are generated such that a difference in the amount of ejected liquid between the first head chips 51a, the second head chips 51b, and the third head chips 51c is reduced. The second drive signal ComC is a signal for driving the drive elements E so as to minutely vibrate menisci MN in the nozzles N in order to prevent the thickening of the liquid in the nozzles N to the extent that the liquid is not ejected from the nozzles N. The second drive signal ComC is not a signal for ejecting liquid, and therefore, a difference in the amount of ejected liquid due to the signal does not occur. Therefore, the second drive signal ComC is common to the head chips 51.

As illustrated in FIG. 5, the first drive signal ComAa has a first starting electrical potential-maintained element a1, a first pulse PAa, and a first ending electrical potential-maintained element a7. The first drive signal generating circuit 241 illustrated in FIG. 2 generates the first drive signal ComAa having the first pulse PAa to be supplied to the first drive element Ea when a large dot is to be ejected from the first nozzle Na.

As illustrated in FIG. 5, the first starting electrical potential-maintained element a1 is an element that maintains a first electrical potential E1a from the start of the single driving cycle Tu to the start of the first pulse PAa. In the present embodiment, the first electrical potential E1a is an intermediate electrical potential of the first pulse PAa and is different from a reference electrical potential E0. The reference electrical potential E0 is, for example, an electrical potential higher than the offset electrical potential VBS.

The first ending electrical potential-maintained element a7 is an element that maintains the first electrical potential E1a from the end of the first pulse PAa to the end of the single driving cycle Tu. In the present embodiment, the first ending electrical potential-maintained element a7 maintains the first electrical potential E1a, but may maintain an electrical potential other than the first electrical potential E1a, for example, the reference electrical potential E0. Therefore, in the present embodiment, the electrical potential of the first starting electrical potential-maintained element a1 and the electrical potential of the first ending electrical potential-maintained element a7 are equal to each other, but may be different from each other.

The first pulse PAa has an expansion element a2, a maintained element a3, an ejection element a4, a maintained element a5, and a return element a6 in this order. The expansion element a2 changes the electrical potential to drive the first drive element Ea so as to increase the volume of the first pressure chamber Ca. The expansion element a2 changes in electrical potential from the first electrical potential E1a to the lowest electrical potential Ex of the first pulse PAa. The maintained element a3 is an element that maintains the lowest electrical potential Ex. The ejection element a4 is an element that changes the electrical potential after the expansion element a2 to drive the first drive element Ea so as to reduce the increased volume of the first pressure chamber Ca such that a large dot, which is a “droplet in the first amount”, is ejected from the first nozzle Na. The ejection element a4 changes in electrical potential from the lowest electrical potential Ex to the highest electrical potential E2a of the first pulse PAa. The maintained element a5 is an element that maintains the highest electrical potential E2a. The return element a6 is an element that returns from the highest electrical potential E2a to the first electrical potential E1a.

As illustrated in FIG. 6, the third drive signal ComAb has a third starting electrical potential-maintained element b1, a third pulse PAb, and a third ending electrical potential-maintained element b7. The third drive signal generating circuit 243 illustrated in FIG. 2 generates the third drive signal ComAb having the third pulse PAb to be supplied to the second drive element Eb when a large dot is to be ejected from the second nozzle Nb.

The third starting electrical potential-maintained element b1 is an element that maintains a third electrical potential E1b from the start of the single driving cycle Tu to the start of the third pulse PAb. The third electrical potential E1b is an intermediate electrical potential of the third pulse PAb, and is equal to the reference electrical potential E0 in the present embodiment. The third electrical potential E1b is different from the first electrical potential E1a.

The third ending electrical potential-maintained element b7 is an element that maintains the third electrical potential E1b from the end of the third pulse PAb to the end of the single driving cycle Tu. In the present embodiment, the third ending electrical potential-maintained element b7 may maintain an electrical potential other than the third electrical potential E1b. Therefore, in the present embodiment, the electrical potential of the third starting electrical potential-maintained element b1 and the electrical potential of the third ending electrical potential-maintained element b7 are equal to each other, but may be different from each other.

The third pulse PAb has an expansion element b2, a maintained element b3, an ejection element b4, a maintained element b5, and a return element b6 in this order. The expansion element b2 changes the electrical potential to drive the second drive element Eb so as to increase the volume of the second pressure chamber Cb. The expansion element b2 changes in electrical potential from the third electrical potential E1b to the lowest electrical potential Ex of the third pulse PAb. The maintained element b3 is an element that maintains the lowest electrical potential Ex. The lowest electrical potential Ex of the third pulse PAb is equal to the lowest electrical potential Ex of the first pulse PAa described above, but may be different from the lowest electrical potential Ex of the first pulse PAa. The ejection element b4 is an element that changes the electrical potential after the expansion element b2 to drive the second drive element Eb so as to reduce the increased volume of the second pressure chamber Cb such that a large dot, which is a “droplet in the first amount”, is ejected from the second nozzle Nb. The ejection element b4 changes in electrical potential from the lowest electrical potential Ex to the highest electrical potential Ey of the third pulse PAb. The maintained element b5 is an element that maintains the highest electrical potential Ey. The highest electrical potential Ey is lower than the highest electrical potential E2a of the first pulse PAa. The return element b6 is an element that returns from the highest electrical potential Ey to the third electrical potential E1b.

As illustrated in FIG. 7, the fourth drive signal ComAc has a fourth starting electrical potential-maintained element c1, a fourth pulse PAc, and a fourth ending electrical potential-maintained element c7. The drive signal generating circuit 24 illustrated in FIG. 2 generates the fourth drive signal ComAc having the fourth pulse PAc to be supplied to the third drive element Ec when a large dot is to be ejected from the third nozzle Nc.

The fourth starting electrical potential-maintained element c1 is an element that maintains a fourth electrical potential E1c from the start of the single driving cycle Tu to the start of the fourth pulse PAc. The fourth electrical potential E1c is an intermediate electrical potential of the fourth pulse PAc. In the present embodiment, the fourth electrical potential E1c is different from the first electrical potential E1a and the reference electrical potential E0.

The fourth ending electrical potential-maintained element c7 is an element that maintains the fourth electrical potential E1c from the end of the fourth pulse PAc to the end of the single driving cycle Tu. In the present embodiment, the fourth ending electrical potential-maintained element c7 may maintain an electrical potential other than the fourth electrical potential E1c, for example, the reference electrical potential E0. Therefore, in the present embodiment, the electrical potential of the fourth starting electrical potential-maintained element c1 and the electrical potential of the fourth ending electrical potential-maintained element c7 are equal to each other, but may be different from each other.

The fourth pulse PAc has an expansion element c2, a maintained element c3, an ejection element c4, a maintained element c5, and a return element c6 in this order. The expansion element c2 changes the electrical potential to drive the third drive element Ec so as to increase the volume of the third pressure chamber Cc. The expansion element c2 changes in electrical potential from the fourth electrical potential E1c to the lowest electrical potential Ex of the fourth pulse PAc. The maintained element c3 is an element that maintains the lowest electrical potential Ex. The lowest electrical potential Ex of the fourth pulse PAc is equal to the lowest electrical potential Ex of the first pulse PAa described above, but may be different from the lowest electrical potential Ex of the first pulse PAa. The ejection element c4 is an element that changes the electrical potential after the expansion element c2 to drive the third drive element Ec so as to reduce the increased volume of the third pressure chamber Cc such that a large dot, which is a “droplet in the first amount”, is ejected from the third nozzle Nc. The ejection element c4 changes in electrical potential from the lowest electrical potential Ex to the highest electrical potential E2c of the fourth pulse PAc. The maintained element c5 is an element that maintains the highest electrical potential E2c. The highest electrical potential E2c is lower than the highest electrical potential E2a of the first pulse PAa and the highest electrical potential Ey of the third pulse PAb. The return element c6 is an element that returns from the highest electrical potential E2c to the fourth electrical potential E1c.

The fifth drive signal ComBa illustrated in FIG. 5 includes a fifth starting electrical potential-maintained element d1, a fifth pulse PBa, and a fifth ending electrical potential-maintained element d2. The drive signal generating circuit 24 illustrated in FIG. 2 generates the fifth drive signal ComBa having the fifth pulse PBa to be supplied to the first drive element Ea when a small dot is to be ejected from the first nozzle Na.

The fifth starting electrical potential-maintained element d1 is an element that maintains the first electrical potential E1a from the start of the single driving cycle Tu to the start of the fifth pulse PBa. The fifth ending electrical potential-maintained element d2 is an element that maintains the first electrical potential E1a from the end of the fifth pulse PBa to the end of the single driving cycle Tu. The electrical potential of the fifth starting electrical potential-maintained element d1 and the electrical potential of the fifth ending electrical potential-maintained element d2 are equal to each other, but may be different from each other. The electrical potential of the fifth starting electrical potential-maintained element d1 and the electrical potential of the fifth ending electrical potential-maintained element d2 may be different from the first electrical potential E1a.

The fifth pulse PBa falls from the first electrical potential E1a to an electrical potential lower than the first electrical potential E1a, maintains the electrical potential, rises to an electrical potential higher than the first electrical potential E1a, maintains the electrical potential, then changes to an electrical potential lower than the first electrical potential E1a, and maintains the electrical potential. Then, the fifth pulse PBa rises to an electrical potential higher than the first electrical potential E1a after maintaining the electrical potential lower than the first electrical potential E1a, and returns to the first electrical potential E1a after maintaining the electrical potential higher than the first electrical potential E1a.

The second drive signal ComC illustrated in FIGS. 5 to 7 includes a second starting electrical potential-maintained element e1, a second pulse PC, and a second ending electrical potential-maintained element e5. The second drive signal generating circuit 242 illustrated in FIG. 2 generates the second drive signal ComC having the second pulse PC different from the first pulse PAa. The second pulse PC is a minute vibration pulse that is supplied to the first drive element Ea when the liquid in the first nozzle Na is to be vibrated so as not to be ejected. The second pulse PC is also a minute vibration pulse that is supplied to the second drive element Eb when the liquid in the second nozzle Nb is to be vibrated so as not to be ejected. The second pulse PC is also a minute vibration pulse that is supplied to the third drive element Ec when the liquid in the third nozzle Nc is to be vibrated so as not to be ejected.

The second starting electrical potential-maintained element e1 is an element that maintains a second electrical potential E3 from the start of the single driving cycle Tu to the start of the second pulse PC. The second ending electrical potential-maintained element e5 is an element that maintains the second electrical potential E3 from the end of the second pulse PC to the end of the single driving cycle Tu. In the present embodiment, the second electrical potential E3 is equal to the reference electrical potential E0. The electrical potential of the second starting electrical potential-maintained element e1 and the electrical potential of the second ending electrical potential-maintained element e5 are equal to each other, but may be different from each other. The electrical potential of the second starting electrical potential-maintained element e1 and the electrical potential of the second ending electrical potential-maintained element e5 may be different from the reference electrical potential E0.

The second pulse PC is a trapezoidal wave and has an expansion element e2, a maintained element e3, and a contraction element e4 in this order. The expansion element e2 changes in electrical potential from the second electrical potential E3 to the lowest electrical potential Ez of the second pulse PC. The maintained element e3 is an element that maintains the lowest electrical potential Ez. The contraction element e4 is an element that returns from the lowest electrical potential Ez to the second electrical potential E3.

The sixth drive signal ComBb illustrated in FIG. 6 includes a sixth starting electrical potential-maintained element f1, a sixth pulse PBb, and a sixth ending electrical potential-maintained element f2. The drive signal generating circuit 24 illustrated in FIG. 2 generates the sixth drive signal ComBb having the sixth pulse PBb to be supplied to the second drive element Eb when a small dot is to be ejected from the second nozzle Nb. The sixth starting electrical potential-maintained element f1 and the sixth ending electrical potential-maintained element f2 maintain the third electrical potential E1b. The sixth pulse PBb is similar to the fifth pulse PBa, but each electrical potential and each rate of change in the electrical potential in the sixth pulse PBb are set such that a small dot is ejected from the second nozzle Nb.

The seventh drive signal ComBc illustrated in FIG. 7 includes a seventh starting electrical potential-maintained element g1, a seventh pulse PBc, and a seventh ending electrical potential-maintained element g2. The drive signal generating circuit 24 illustrated in FIG. 2 generates the seventh drive signal ComBc having the seventh pulse PBc to be supplied to the third drive element Ec when a small dot is to be ejected from the third nozzle Nc. The seventh starting electrical potential-maintained element g1 and the seventh ending electrical potential-maintained element g2 maintain the fourth electrical potential E1c. The seventh pulse PBc is similar to the fifth pulse PBa, but each electrical potential and each rate of change in the electrical potential in the seventh pulse PBc are set such that a small dot is ejected from the third nozzle Nc.

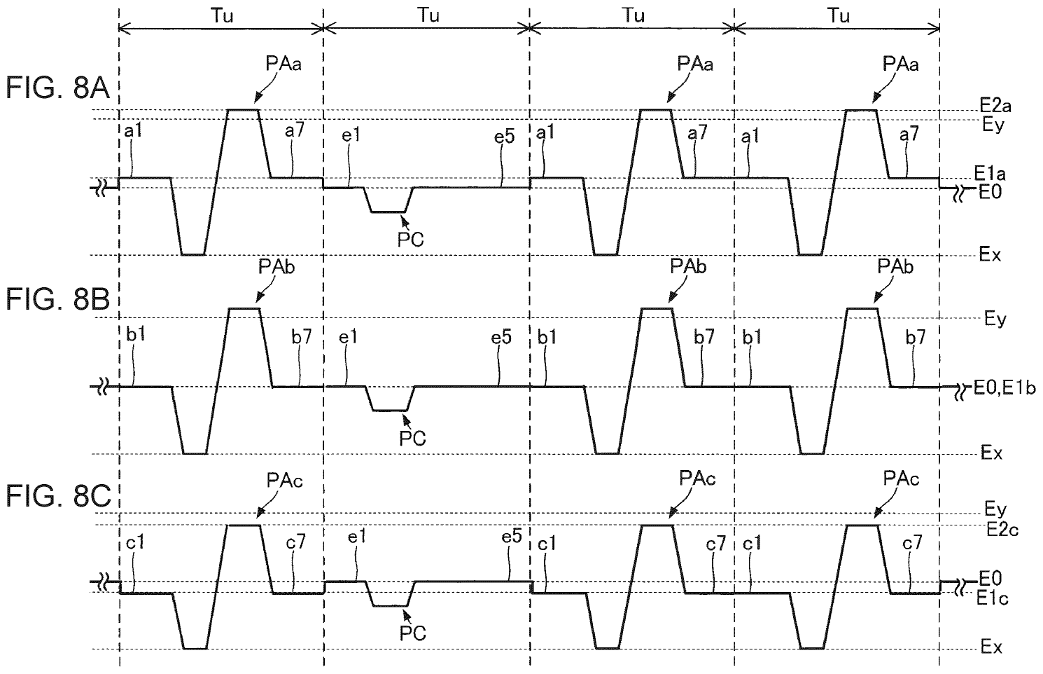

FIGS. 8A to 8C are diagrams illustrating an example of a case where driving cycles Tu are continuous. In FIGS. 8A to 8C, for example, in the first driving cycle Tu, each of the plurality of ejection sections 510 performs ejection driving to form a large dot which is a “droplet in the first amount”. In the second driving cycle Tu, each of the plurality of ejection sections 510 performs micro-vibration driving. In the third driving period Tu, each of the plurality of ejection sections 510 performs ejection driving to form a large dot. In the fourth driving period Tu, each of the plurality of ejection sections 510 performs ejection driving to form a large dot.

FIG. 8A illustrates a drive waveform of a supply signal Vin supplied to the first drive elements Ea of the first head chips 51a. FIG. 8B illustrates a drive waveform of a supply signal Vin supplied to the second drive elements Eb of the second head chips 51b. FIG. 8C illustrates a drive waveform of a supply signal Vin supplied to the third drive elements Ec of the third head chips 51c.

As illustrated in FIG. 8A, in each of the first head chips 51a, the first drive signal ComAa is supplied to each of the first drive elements Ea in the third driving cycle Tu and the fourth driving cycle Tu. The first ending electrical potential-maintained element a7 included in the first drive signal ComAa in the third driving cycle Tu and the first starting electrical potential-maintained element a1 included in the first drive signal ComAa in the fourth driving cycle Tu are both at the first electrical potential E1a, and the first electrical potential E1a is continuous for a time period in which the third driving cycle Tu changes to the fourth driving cycle Tu.

In each of the first head chips 51a, the first drive signal ComAa is supplied to each of the first drive elements Ea in the first driving cycle Tu, and the second drive signal ComC is supplied to each of the first drive elements Ea in the second driving cycle Tu. The first ending electrical potential-maintained element a7 included in the first drive signal ComAa in the first drive cycle Tu and the second starting electrical potential-maintained element e1 included in the second drive signal ComC in the second drive cycle Tu are at different electrical potentials.

As illustrated in FIG. 8B, in each of the second head chips 51b, the third drive signal ComAb is supplied to each of the second drive elements Eb in the third driving cycle Tu and the fourth driving cycle Tu. The third ending electrical potential-maintained element b7 included in the third drive signal ComAb in the third driving cycle Tu and the third starting electrical potential-maintained element b1 included in the third drive signal ComAb in the fourth driving cycle Tu are both at the third electrical potential E1b, and the third electrical potential E1b is continuous for the time period in which the third driving cycle Tu changes to the fourth driving cycle Tu.

In each of the second head chips 51b, the third drive signal ComAb is supplied to each of the second drive elements Eb in the first driving cycle Tu, and the second drive signal ComC is supplied to each of the second drive elements Eb in the second driving cycle Tu. The third ending electrical potential-maintained element b7 included in the third drive signal ComAb in the first driving cycle Tu and the second starting electrical potential-maintained element e1 included in the second drive signal ComC in the second driving cycle Tu are both at the same electrical potential, and the reference electrical potential E0 is continuous for a time period in which the first driving cycle Tu changes to the second driving cycle Tu.

As illustrated in FIG. 8C, in each of the third head chips 51c, the fourth drive signal ComAc is supplied to each of the third drive elements Ec in the third driving cycle Tu and the fourth driving cycle Tu. The fourth ending electrical potential-maintained element c7 included in the fourth drive signal ComAc in the third driving cycle Tu and the fourth starting electrical potential-maintained element c1 included in the fourth drive signal ComAc in the fourth driving cycle Tu are both at the fourth electrical potential E1c, and the fourth electrical potential E1c is continuous for the time period in which the third driving cycle Tu changes to the fourth driving cycle Tu.

In each of the third head chips 51c, the fourth drive signal ComAc is supplied to each of the third drive elements Ec in the first driving cycle Tu, and the second drive signal ComC is supplied to each of the third drive elements Ec in the second driving cycle Tu. The fourth ending electrical potential-maintained element c7 included in the fourth drive signal ComAc in the first drive cycle Tu and the second starting electrical potential-maintained element e1 included in the second drive signal ComC in the second drive cycle Tu are at different electrical potentials.

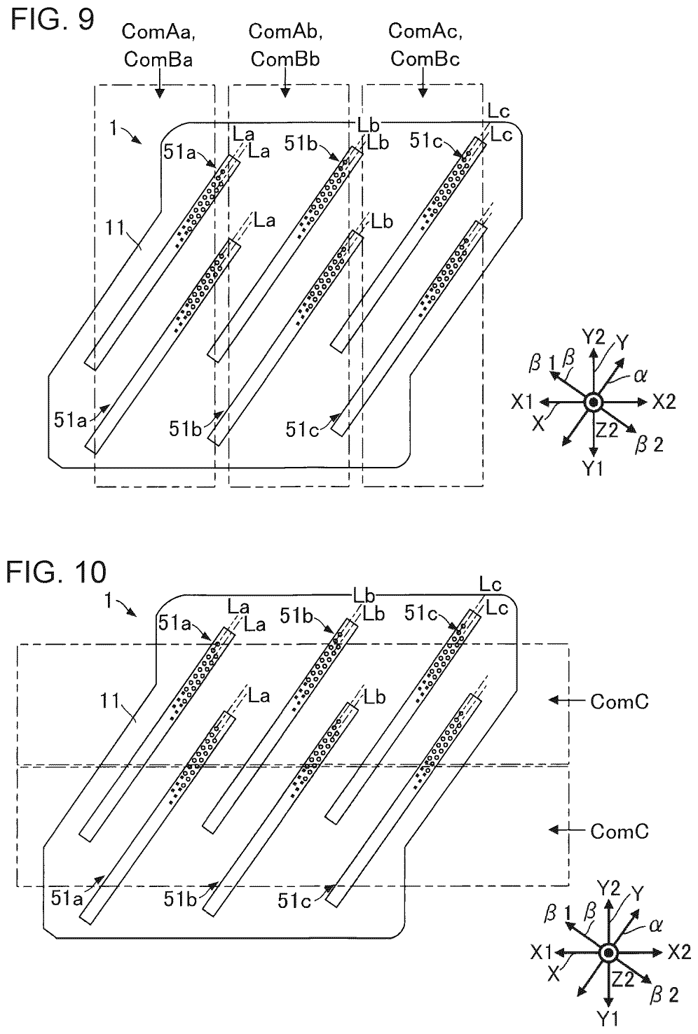

FIGS. 9 and 10 are diagrams for explaining the supply of the drive signal Com. In the present embodiment, as illustrated in FIG. 9, the same drive signal Com is supplied to the head chips 51 arranged in the Y1 direction which is the transport direction of the medium M, as the drive signal Com related to the ejection of the liquid. Specifically, the first drive signal ComAa and the fifth drive signal ComBa are supplied to the two first head chips 51a. The third drive signal ComAb and the sixth drive signal ComBb are supplied to the two second head chips 51b. The fourth drive signal ComAc and the seventh drive signal ComBc are supplied to the two third head chips 51c.

In the present embodiment, as illustrated in FIG. 10, the second drive signal ComC which is not related to the ejection of the liquid from the nozzles N is common to the head chips 51 arranged in the X1 direction intersecting the transport direction of the medium M. Specifically, the same second drive signal ComC is supplied to one first head chip 51a, one second head chip 51b, and one third head chip 51c which are located in an upper stage in FIG. 10. In addition, the same second drive signal ComC is supplied to one first head chip 51a, one second head chip 51b, and one third head chip 51c which are located in a lower stage in FIG. 10. The drive signal generating circuit 24 may generate two second drive signals ComC, that is, the second drive signal ComC having the second pulse PC to be supplied to the drive elements E of the one first head chip 51a, the one second head chip 51b, and the one third head chip 51c which are located in the upper stage in FIG. 10 and the second drive signal ComC having the second pulse PC to be supplied to the drive elements E of the one first head chip 51a, the one second head chip 51b, and the one third head chip 51c which are located in the lower stage in FIG. 10. Alternatively, the drive signal generating circuit 24 may generate one second drive signal ComC and supply the same second drive signal ComC to all of the first to third head chips 51a to 51c.

In the present embodiment, the second drive signal ComC is the same for all of the head chips 51, but second drive signals ComC having waveform shapes different from each other for the upper stage and the lower stage in FIG. 10 may be supplied.

In this manner, paths through which signals are supplied may differ for a signal related to the ejection of the liquid and a signal not related to the ejection of the liquid. For example, both of the signal related to the ejection of the liquid and the signal not related to the ejection of the liquid may be supplied to each of the head chips 51 arranged in the Y1 direction which is the transport direction of the medium M.

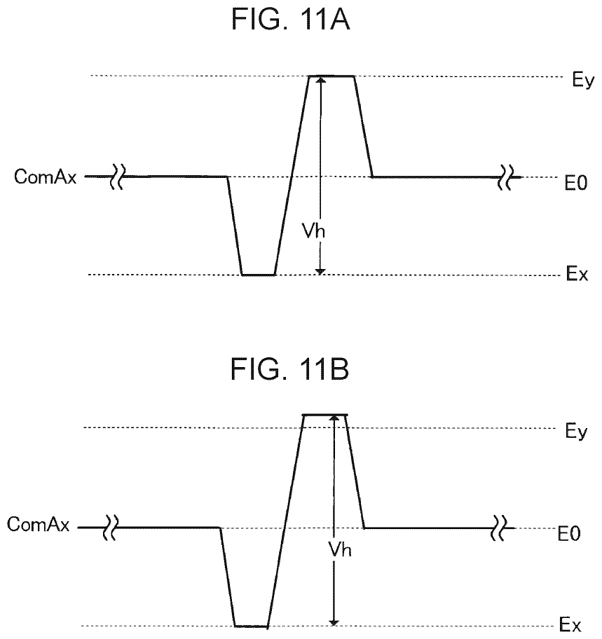

FIGS. 11A and 11B are diagrams for explaining correction of a drive signal ComAx in the related art. As illustrated in FIG. 11, in the related art, a peak value Vh is corrected without changing an intermediate electrical potential of the drive signal ComAx such that the amount of liquid to be ejected is adjusted to a desired amount of liquid to be ejected. Specifically, for example, when the amount of liquid to be ejected is insufficient with reference to the drive signal ComAx illustrated in FIG. 11A, the peak value Vh is increased to correct the drive signal ComAx illustrated in FIG. 11A to the drive signal ComAx illustrated in FIG. 11B. However, in this case, even when the peak value Vh is increased or decreased, the amount of liquid to be ejected may not be adjusted to a desired amount. Specifically, it is difficult to adjust the amount of liquid to be ejected to a desired amount in high-frequency driving, compared to low-frequency driving.

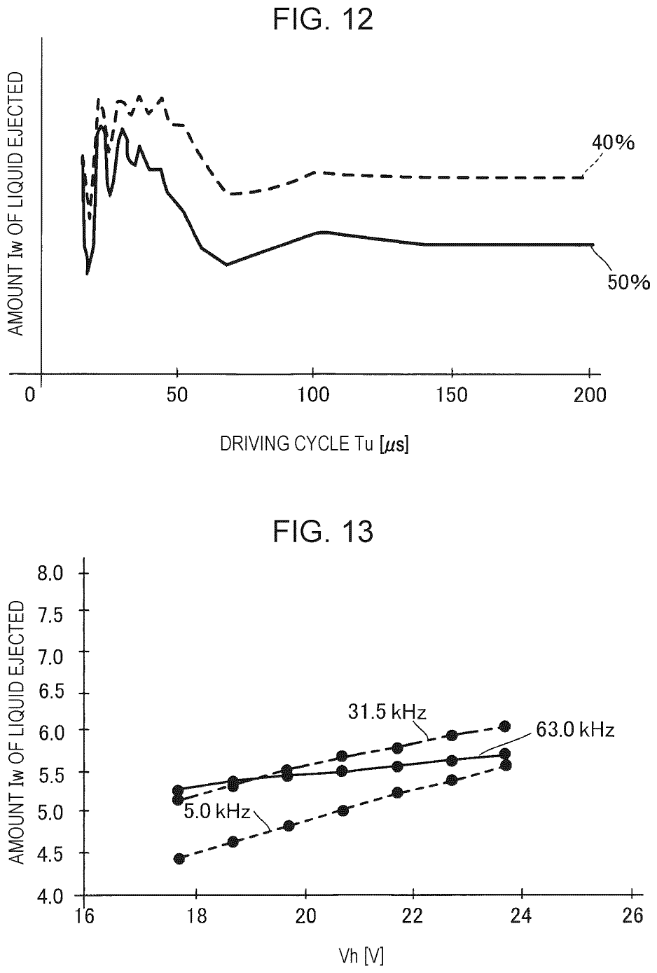

FIG. 12 is a diagram illustrating a relationship between a driving cycle Tu and an amount of liquid to be ejected according to the drive signal ComAx in the related art. FIG. 12 illustrates a case where a ratio of the intermediate electrical potential to the peak value Vh is 40% and a case where the ratio is 50%. When the intermediate electrical potential is not changed, the peak value Vh when the ratio of the intermediate electrical potential to the peak value Vh is 40% is greater than that when the ratio is 50%.

As illustrated in FIG. 12, by changing the ratio of the intermediate electrical potential to the peak value Vh from 50% to 40%, that is, by increasing the peak value Vh, the amount Iw of liquid to be ejected increases when the driving cycle Tu is 40 [μs] or longer. However, a change in the amount of liquid to be ejected when the driving cycle Tu is short, that is, when the frequency is high, is smaller than a change in the amount of liquid to be ejected when the driving cycle Tu is long, that is, when the frequency is low. That is, the amount of change in the amount of liquid to be ejected per 1 V of the peak value Vh decreases as the driving frequency increases.

FIG. 13 is a diagram illustrating a relationship between the peak value Vh and the amount Iw of liquid to be ejected for each frequency according to the drive signal ComAx in the related art. FIG. 13 illustrates the relationship between the peak value Vh and the amount Iw of liquid to be ejected when the frequency is 5.0 kHz, 31.5 kHz, and 63.0 kHz. As illustrated in FIG. 13, when the frequency is 63.0 kHz, even if the peak value Vh is changed, a change in the amount Iw of liquid to be ejected is small, compared to cases where the frequency is 5.0 kHz and 31.5 kHz. That is, the amount of change in the amount of liquid to be ejected per 1 V of the peak value Vh in the high-frequency driving is smaller than that in the low-frequency driving. Therefore, when an amount by which the peak value Vh is corrected is further increased in order to secure the amount of liquid to be ejected in the high-frequency driving, the speed at which a droplet is ejected becomes excessively higher than a desired speed in the low-frequency driving. As a result, the landing position may deviate from an appropriate position.

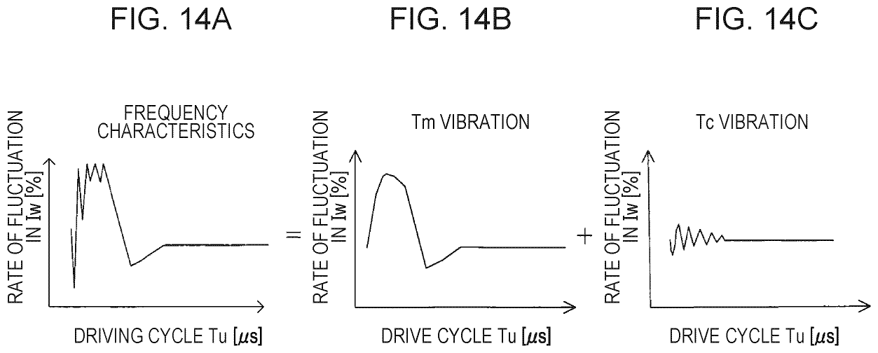

FIGS. 14A to 14C are diagrams for explaining frequency characteristics. The frequency characteristics illustrated in FIG. 14A are determined based on the sum of the relationship between the driving frequency and the amount Iw of liquid to be ejected due to an effect of Tm vibration which is vibration of menisci MN in the nozzles N illustrated in FIG. 14B and the relationship between the driving frequency and the amount Iw of liquid to be ejected due to an effect of Tc vibration which is vibration in the flow paths of the ejection sections 510 illustrated in FIG. 14C. In particular, the effect of the Tm vibration is large in the high-frequency driving. Therefore, in the low-frequency driving, an effect of residual vibration which is Tc vibration after a droplet is ejected and an effect of refilling which causes Tm vibration after a droplet is ejected are smaller than those in the high-frequency driving. In the low-frequency driving, after the menisci MN return to the state at the time of non-driving, the next drive signal Com is applied. On the other hand, in the high-frequency driving, the amount of liquid to be ejected easily changes due to the effect of the Tm vibration of the menisci MN in the nozzles N and the Tc vibration in the flow paths of the ejection sections 510.

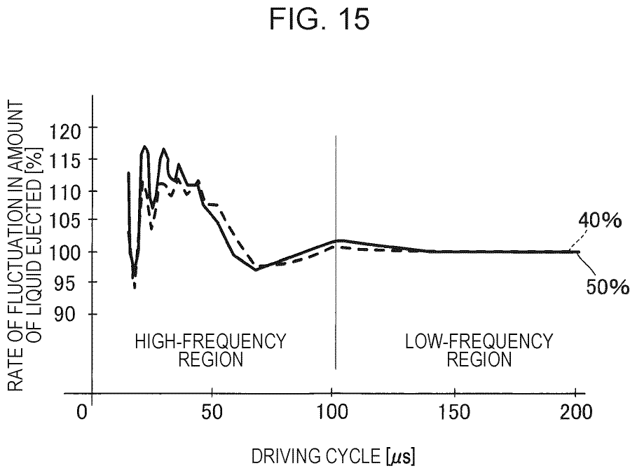

FIG. 15 is a diagram for explaining an effect of the frequency characteristics on the amount of liquid to be ejected. FIG. 15 illustrates changes in the amount Iw of liquid ejected according to the driving frequency when the ratio of the intermediate electrical potential to the peak value Vh is 50% and 40%, and a difference between the changes in the amount Iw of liquid ejected when the driving frequency is in a high frequency region. The vertical axis in FIG. 15 represents the rate [%] of fluctuation in the amount of liquid ejected when the rate of fluctuation in the amount Iw of liquid ejected in a low frequency region in which the ratio is 50% and 40% is set to 100%. As illustrated in FIG. 15, when the ratio of the intermediate electrical potential to the peak value Vh is 40%, the rate of fluctuation in the amount of liquid ejected is lower than that when the ratio is 50%. That is, in the high-frequency driving, even when an amount by which the peak value Vh is corrected is increased without changing the intermediate electrical potential, the amount Iw of liquid to be ejected is unlikely to increase. Therefore, it is more difficult to increase the amount Iw of liquid to be ejected as the driving frequency becomes higher in the correction method of changing only the peak value Vh in the related art.

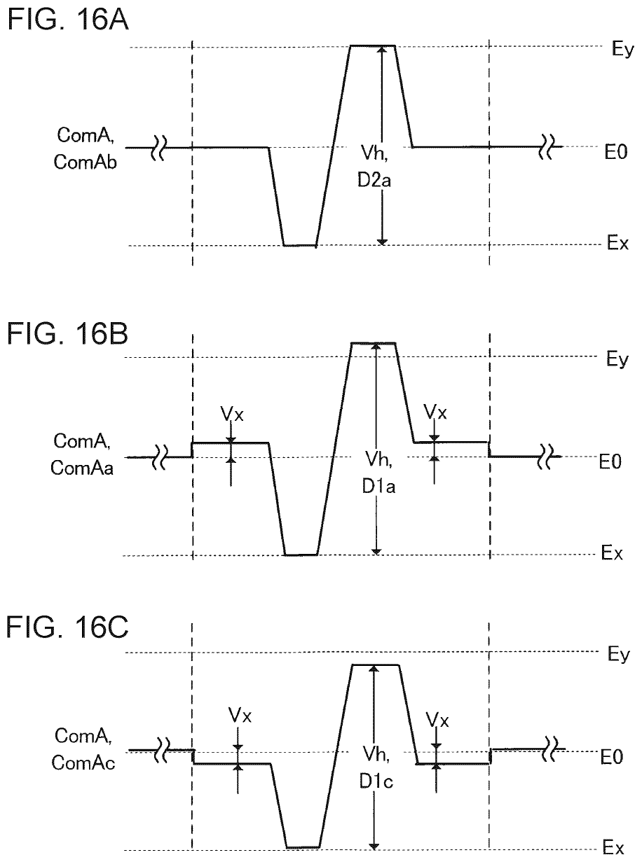

FIGS. 16A to 16C are diagrams for explaining the correction of the large dot drive signal ComA according to the present embodiment. As illustrated in FIGS. 16A to 16C, in the present embodiment, the intermediate electrical potential is corrected together with the correction of the peak value Vh.

Specifically, for example, when the large dot drive signal ComA illustrated in FIG. 16A is supplied to the drive element E of the head chip 51 and the amount of a droplet to be ejected from the nozzle N is insufficient for the large dot, the large dot drive signal ComA illustrated in FIG. 16A is corrected to the large dot drive signal ComA illustrated in FIG. 16B by increasing the peak value Vh and increasing the intermediate electrical potential. The large dot drive signal ComA illustrated in FIG. 16A is the same as the third drive signal ComAb illustrated in FIG. 6 described above. The large dot drive signal ComA illustrated in FIG. 16B is the same as the first drive signal ComAa illustrated in FIG. 5 described above.

Specifically, for example, when the large dot drive signal ComA illustrated in FIG. 16A is supplied to the drive element E of the head chip 51 and the amount of a droplet to be ejected from the nozzle N is excessive for the large dot, the large dot drive signal ComA illustrated in FIG. 16A is corrected to the large dot drive signal ComA illustrated in FIG. 16C by reducing the peak value Vh and lowering the intermediate electrical potential. The large dot drive signal ComA illustrated in FIG. 16C is the same as the fourth drive signal ComAc illustrated in FIG. 7 described above.

In this way, in the present embodiment, since the intermediate electrical potential is corrected together with the correction of the peak value Vh, it is possible to increase the amount of liquid to be ejected while suppressing the peak value Vh even in the high-frequency driving, compared to a case where only the peak value Vh is corrected.

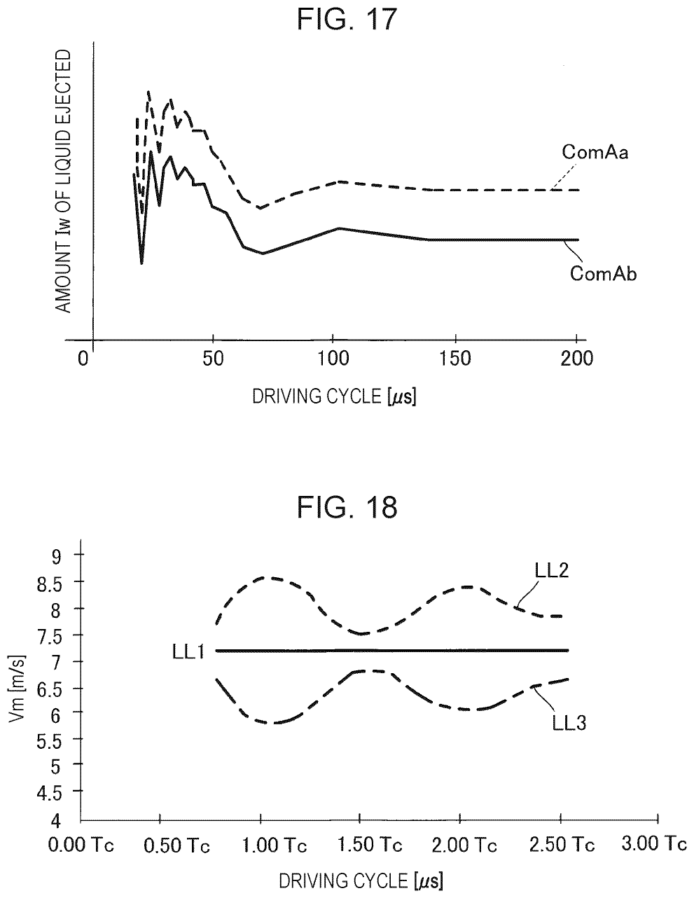

FIG. 17 is a diagram illustrating a relationship between a driving cycle Tu and the amount Iw of liquid to be ejected in the correction of the large dot drive signal ComA in the present embodiment. FIG. 17 illustrates the relationship between the driving cycle Tu and the amount Iw of liquid to be ejected when the first drive signal ComAa and the third drive signal ComAb are supplied to each drive element E of a predetermined head chip 51. A range D2a of change in the electrical potential that is the peak value Vh of the first drive signal ComAa is larger than a range D2b of change in the electrical potential that is the peak value Vh of the third drive signal ComAb. In addition, the first electrical potential E1a of the first starting electrical potential-maintained element a1 which is the intermediate electrical potential of the first drive signal ComAa is higher than the third electrical potential E1b (reference electrical potential E0) of the third starting electrical potential-maintained element b1 which is the intermediate electrical potential of the third drive signal ComAb. Therefore, the ratio of the intermediate electrical potential to the peak value Vh of the first drive signal ComAa and the ratio of the intermediate electrical potential to the peak value Vh of the third drive signal ComAb are equal to 50%.

As illustrated in FIG. 17, the amount of liquid to be ejected according to the first drive signal ComAa is larger than that according to the third drive signal ComAb regardless of the frequencies. In the present embodiment, compared to the third drive signal ComAb, the amount of liquid to be ejected according to the first drive signal ComAa is increased in the high frequency region as in the low frequency region. That is, by supplying the drive signal ComA having the waveform shape of the first drive signal ComAa to the head chip 51 from which a droplet in an amount smaller than a droplet amount corresponding to the large dot is ejected by the drive signal ComA having the waveform shape of the third drive signal ComAb, it is possible to increase the amount of liquid to be ejected. Therefore, in the present embodiment, as compared to the related art, a situation in which the amount of change in the amount of liquid ejected per 1 V is not small due to the frequencies is reduced.

Note that the same applies to the fourth drive signal ComAc.

As described above, the first electrical potential E1a of the first starting electrical potential-maintained element a1 of the first drive signal ComAa and the second electrical potential E3 of the second starting electrical potential-maintained element e1 of the second drive signal ComC are different from each other. As described above, since the electrical potential of the first starting electrical potential-maintained element a1 of the first drive signal ComAa and the electrical potential of the second starting electrical potential-maintained element e1 of the second drive signal ComC are different from each other, it is possible to increase the degree of freedom in design, compared to a case where the potentials are equal. For example, as described above, by adjusting the first electrical potential E1a in addition to the peak value Vh, the amount of liquid to be ejected and the ejection speed can be easily set to be close to a desired amount and a desired speed. As described above, since the intermediate electrical potential is corrected together with the correction of the peak value Vh, the amount of liquid to be ejected and the ejection speed are less affected by a change in the frequency characteristics described above, and thus it is easy to adjust the amount of liquid to be ejected and the ejection speed to a desired amount and a desired speed.

Furthermore, as described above, the reference electrical potential E0 as the “third electrical potential” of the third starting electrical potential-maintained element b1 of the third drive signal ComAb is different from the first electrical potential E1a of the first starting electrical potential-maintained element a1 of the first drive signal ComAa. Thus, it is possible to secure the degree of freedom in designing the first drive signal ComAa and the third drive signal ComAb. Therefore, when the same large dots are to be ejected from the first nozzle Na and the second nozzle Nb, since the electrical potential of the first starting electrical potential-maintained element a1 and the electrical potential of the third starting electrical potential-maintained element b1 are different from each other, it is possible to more accurately align the amounts of the dots to be ejected, compared to a case where the electrical potentials are equal. That is, the difference between the amounts of the dots to be ejected can be reduced.

As illustrated in FIG. 5 or 6, a range D1a of change in the electrical potential of the expansion element a2 of the first pulse PAa is different from a range D1b of change in the electrical potential of the ejection element b4 of the third pulse PAb, and a range D2a of change in the electrical potential of the ejection element a4 of the first pulse PAa is different from a range D2b of change in the electrical potential of the ejection element b4 of the third pulse PAb. Thus, in accordance with the fact that the electrical potential of the first starting electrical potential-maintained element a1 and the electrical potential of the third starting electrical potential-maintained element b1 are different from each other, the ranges D1a and D1b of change in the electrical potentials are different, and the ranges D2a and D2b of change in the electrical potentials are different. Therefore, as described above, it is possible to reduce the effect of the frequency characteristics, and thus it is possible to reduce a difference in the amount of a large dot ejected which is the same droplet between the first nozzle Na and the second nozzle Nb.

The first drive signal ComAa is supplied to the first drive elements Ea without being supplied to the second drive elements Eb. The third drive signal ComAb is supplied to the second drive elements Eb without being supplied to the first drive elements Ea. In addition, the second drive signal ComC including the second pulse PC which is a minute vibration pulse is supplied to the first drive elements Ea and the second drive elements Eb. That is, the first drive signal ComAa is a dedicated ejection drive signal for ejecting a large dot from each of the first nozzles Na, and the third drive signal ComAb is a dedicated ejection drive signal for ejecting a large dot from each of the second nozzles Nb. On the other hand, the second drive signal ComC is not a signal related to ejection, and is a micro-vibration drive signal for only vibrating the menisci MN. By using the micro-vibration drive signal in common for the plurality of drive elements E, it is possible to suppress complexity of the drive signal generating circuit 24.

The second electrical potential E3 of the second starting electrical potential-maintained element e1 is within a range from the first electrical potential E1a of the first starting electrical potential-maintained element a1 to the third electrical potential E1b of the third starting electrical potential-maintained element b1. In the present embodiment, the second electrical potential E3 and the third electrical potential E1b are equal to each other.

Since the second electrical potential E3 is within the range, the difference between the electrical potentials when the first driving cycle Tu in which the first pulse PAa is supplied changes to the second driving cycle Tu in which the second pulse PC is supplied is suppressed so as not to be excessively large even when the first pulse PAa and the second pulse PC are continuous as indicated in the first and second driving cycles Tu in FIG. 8A, compared to a case where the second potential E3 is out of the range. Thus, it is possible to perform stable ejection and micro-vibration driving. Therefore, it is possible to prevent droplets from being unintentionally ejected in the micro-vibration driving, and to prevent the amount of a large dot ejected and the ejection speed from being unstable in the ejection of the large dot.

The first ending electrical potential-maintained element a7 of the first drive signal ComAa maintains the first electrical potential E1a equal to that of the first starting electrical potential-maintained element a1. For this reason, when the first pulse PAa is repeatedly output as indicated in the third and fourth driving cycles Tu in FIG. 8A, the electrical potentials are prevented from being different when the third driving cycle Tu changes to the fourth driving cycle Tu. Therefore, stable ejection can be performed.

Similarly, the third ending electrical potential-maintained element b7 of the third drive signal ComAb maintains the third electrical potential E1b equal to that of the third starting electrical potential-maintained element b1. For this reason, when the third pulse PAb is repeatedly output as indicated in the third and fourth driving cycles Tu in FIG. 8B, the electrical potentials are prevented from being different when the third driving cycle Tu changes to the fourth driving cycle Tu. Therefore, stable ejection can be performed.

It is preferable that the highest ejection frequency determined by the first drive signal ComAa and the third drive signal ComAb be higher than or equal to 10 kHz. In a high frequency region higher than or equal to 10 kHz, the first electrical potential E1a is different from the third electrical potential E1b, and thus the above-described effect is significantly exhibited.

The highest ejection frequency determined by the first drive signal ComAa and the third drive signal ComAb is, for example, about 150 kHz or less in consideration of stable ejection.

As illustrated in FIG. 2, the control unit 20 includes the ejection amount information acquirer 25 and the controller 210. The ejection amount information acquirer 25 acquires first ejection amount information InAa regarding the amount of a droplet to be ejected from each of the first nozzles Na. The controller 210 generates first drive signal information InBa for specifying the waveform of the first drive signal ComAa based on the first ejection amount information InAa, and transmits the first drive signal information InBa to the first drive signal generating circuit 241. The controller 210 changes at least one of the range D1a of change in the electrical potential of the expansion element a2 of the first pulse PAa, the range D2a of change in the electrical potential of the ejection element a4 of the first pulse PAa, and the first electrical potential E1a based on the first ejection amount information InAa.

For example, in the use of each of the liquid ejecting heads 50, an amount of liquid ejected may vary due to a change over time in the shape or the like of an element included in the liquid ejecting head 50, the temperature of a location where the liquid ejecting head 50 is used, or the like. Even in such a case, since the control unit 20 includes the ejection amount information acquirer 25 and the controller 210, it is possible to adjust the amounts of liquid to be ejected to desired amounts according to the change over time, the temperature of the location of use, and the like. In addition, it is possible to reduce a difference in the amount of ejected liquid between the plurality of nozzles N which eject droplets of the same size.

The ejection amount information acquirer 25 acquires second ejection amount information InAb regarding the amount of a droplet to be ejected from each of the second nozzles Nb. The controller 210 generates second drive signal information InBb for specifying the waveform of the third drive signal ComAb based on the second ejection amount information InAb, and transmits the second drive signal information InBb to the second drive signal generating circuit 242. The controller 210 changes at least one of the range D1b of change in the electrical potential of the expansion element b2 of the third pulse PAb, the range D2b of change in the electrical potential of the ejection element b4 of the third pulse PAb, and the third electrical potential E1b based on the second ejection amount information InAb.

Since the ejection amount information acquirer 25 and the controller 210 are provided, it is possible to reduce the occurrence of a difference in the amount of ejected liquid between the first nozzles Na and the second nozzles Nb when the same large dots are to be ejected from the first nozzles Na and the second nozzles Nb according to the above-described change over time, the temperature of the location of use, and the like. The ejection amount information acquirer 25 and the controller 210 correct the ranges of change in the electrical potentials of the other pulses and the intermediate electrical potentials of the other pulses in the same manner as described above. Therefore, it is possible to reduce a difference in the amount of ejected liquid between the plurality of nozzles N which eject droplets of the same size.

FIG. 18 is a diagram illustrating the speed Vm at which a large dot is ejected in a succeeding driving cycle Tu when an intermediate electrical potential is changed when a preceding driving cycle Tu changes to the succeeding driving cycle Tu. FIG. 18 illustrates LL1 indicating the speed Vm at which a large dot is ejected in the succeeding driving cycle Tu when the intermediate electrical potential is not changed when the preceding driving cycle Tu changes to the succeeding driving cycle Tu. FIG. 18 illustrates LL2 indicating the speed Vm at which a large dot is ejected in the succeeding driving cycle Tu when the difference between the intermediate electrical potential in the preceding driving cycle Tu and the intermediate electrical potential in the succeeding driving cycle Tu is +2 V when the preceding driving cycle Tu changes to the succeeding driving cycle Tu. FIG. 18 illustrates LL3 indicating the speed Vm at which a large dot is ejected in the succeeding driving cycle Tu when the difference between the intermediate electrical potential in the preceding driving cycle Tu and the intermediate electrical potential in the succeeding driving cycle Tu is −2 V when the preceding driving cycle Tu changes to the succeeding driving cycle Tu. In the example illustrated in FIG. 18, when the driving cycle changes, a time period from the start of the driving cycle to the start of an ejection pulse changes.

As illustrated in FIG. 18, when the intermediate electrical potential is changed when the driving cycle Tu changes to the next driving cycle Tu, the drive element E is driven by the change in the electrical potential to cause pressure applied to the liquid in the pressure chamber C and the nozzle N to fluctuate such that the liquid is vibrated. When an ejection pulse is applied at a timing at which the ejection pulse resonates or does not resonate with the pressure vibration, the ejection characteristics greatly change. Therefore, it is preferable to use the length of the first starting electrical potential-maintained element a1 within a range in which the effect of the ejection speed due to the difference between the intermediate electrical potentials when the driving cycle Tu changes to the next driving cycle Tu is small.

Specifically, it is preferable that the time period tx from the start of the first starting electrical potential-maintained element a1 to an intermediate point of the expansion element a2 of the first pulse PAa illustrated in FIG. 5 satisfy the following inequality.

$$25 \times T C + n \leq t x \leq 0.75 \times T C + n$$

TC described above is a natural vibration period of the first ejection section 510a, and n is a natural number.

When the time period tx satisfies the above-described inequality, it is possible to increase the stability of the ejection even when the intermediate electrical potential is changed when the driving cycle Tu changes to the next driving cycle Tu, compared to a case where the time period tx does not satisfy the above-described inequality.

Furthermore, the time period tx preferably satisfies the following equation.

$$t x = 0.5 \times T C + n$$

When the time period tx satisfies the above-described equation, it is possible to particularly improve the stability of the ejection, compared to a case where the time period tx does not satisfy the equation.

Similarly, the time period tx from the start of the third starting electrical potential-maintained element b1 illustrated in FIG. 6 to an intermediate point of the expansion element b2 of the third pulse PAb preferably satisfies the following inequality.

$$25 \times T C + n \leq t x \leq 0.75 \times T C + n$$

TC described above is a natural vibration period of the second ejection section 510b, and n is a natural number.

When the time period tx satisfies the above-described inequality, it is possible to increase the stability of the ejection even when the intermediate electrical potential is changed when the driving cycle Tu changes to the next driving cycle Tu, compared to a case where the time period tx does not satisfy the above-described inequality.

Furthermore, the time period tx preferably satisfies the following equation.

$$t x = 0.5 \times T C + n$$

When the time period tx satisfies the above-described equation, it is possible to particularly improve the stability of the ejection, compared to a case where the time period tx does not satisfy the equation.

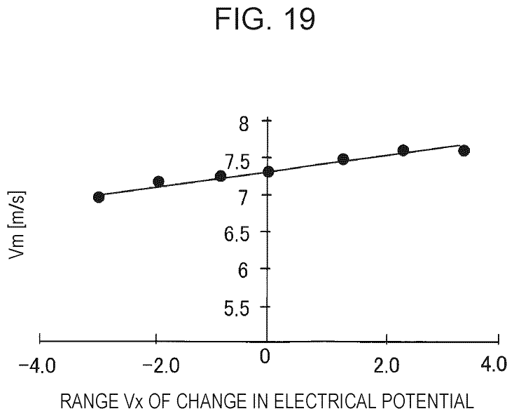

FIG. 19 is a diagram illustrating the ejection speed Vm when a range Vx of change in the electrical potential is changed when a driving cycle Tu changes to a next driving cycle Tu. In other words, the range Vx of change in the electrical potential indicates a difference between an intermediate electrical potential in a preceding driving cycle Tu out of two continuous driving cycles Tu and an intermediate electrical potential in a succeeding driving cycle Tu out of the two continuous driving cycles Tu. As illustrated in FIG. 19, as the absolute value of the range Vx of change in the electrical potential when the driving cycle Tu changes to the next driving cycle Tu increases, the ejection speed Vm is more affected by the range Vx.

The range Vx of change in the electrical potential when the driving cycle Tu changes to the next driving cycle Tu is preferably 4.0 V or less. Therefore, the difference between the first electrical potential E1a and the second electrical potential E3 is preferably 4.0 V or less. When the difference is 4.0 V or less, it is possible to increase the stability of the ejection, compared to a case where the difference exceeds 4.0 V.

Similarly, the difference between the second electrical potential E3 and the third electrical potential E1b is preferably 4.0 V or less. When the difference is 4.0 V or less, it is possible to increase the stability of the ejection, compared to a case where the difference exceeds 4.0 V.

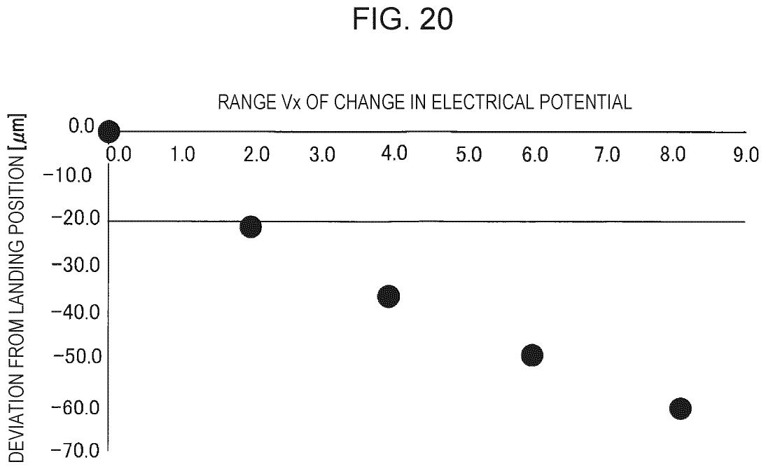

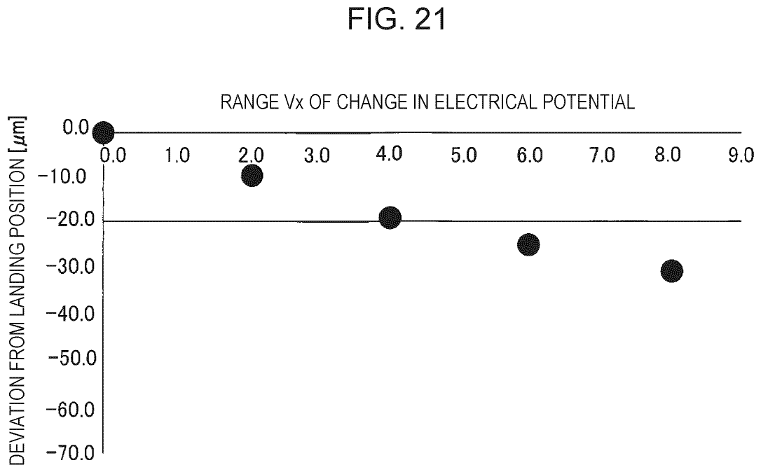

FIG. 20 is a diagram illustrating deviations from a landing position when the range Vx of change in the electrical potential is changed while the transport speed is 80 m/min. FIG. 21 is a diagram illustrating deviations from the landing position when the range Vx of change in the electrical potential is changed while the transport speed is 40 m/min. As illustrated in FIGS. 20 and 21, as the range Vx of change in the electrical potential increases, the ejection becomes more unstable, and the deviation from the landing position increases. As the transport speed increases, the effect of the range Vx of change in the electrical potential increases. In consideration of such deviations from the landing position, the range Vx of change in the electrical potential is preferably 4.0 V or less.

As described above, in the method of driving the liquid ejecting apparatus 100, the first electrical potential E1a of the first starting electrical potential-maintained element a1 of the first drive signal ComAa is set to be different from the second electrical potential E3 of the second starting electrical potential-maintained element e1 of the second drive signal ComC. As described above, since the electrical potential of the first starting electrical potential-maintained element a1 of the first drive signal ComAa and the electrical potential of the second starting electrical potential-maintained element e1 of the second drive signal ComC are set to be different from each other, it is possible to increase the degree of freedom in design, compared to a case where the potentials are equal. For example, as described above, by adjusting the first electrical potential E1a in addition to the peak value Vh, the amount of liquid to be ejected and the ejection speed can be easily set to be close to a desired amount and a desired speed. Therefore, according to the method of driving the liquid ejecting apparatus 100 according to the present embodiment, it is possible to sufficiently correct the amount of liquid to be ejected and the ejection speed.

### B: Modifications

Each of the above-described embodiments can be variously modified. Specific modifications that can be applied to each of the above-described embodiments will be described below. Two or more aspects freely selected from the following examples can be appropriately combined within a range in which the two or more aspects do not contradict each other.

### B1. First Modification

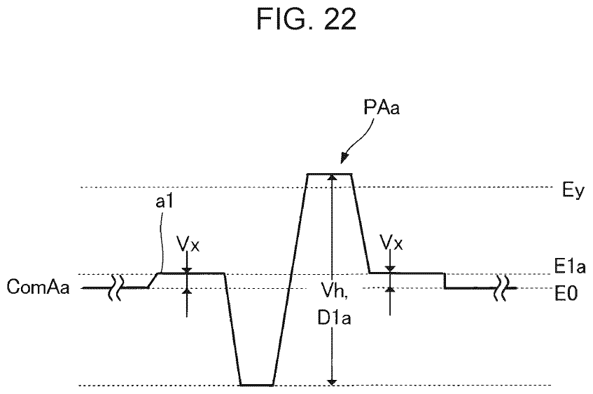

FIG. 22 is a diagram illustrating a first drive signal ComAa according to a first modification. In the above-described embodiment, the change in the electrical potential from the reference potential E0 to the first electrical potential E1a is steep, but the change may be gentle as in the first modification in FIG. 22. Thus, it is possible to suppress instability of the ejection due to a change in the range Vx of change in the electrical potential when the driving cycle Tu changes to the next driving cycle Tu as described above. The same applies to the drive signals Com other than the first drive signal ComAa.

### B2. Other Modifications

In the above-described embodiment, each of the head chips 51 has two nozzle rows L. However, the number of nozzle rows included in each of the head chips 51 may be one or three or more.

A “droplet in the first amount” is not limited to a large dot, and may be a medium dot or a small dot. The “droplet in the first amount” indicates the size of such a droplet, and a difference in the amount of ejected liquid between the nozzles N due to a manufacturing error and an assembly error of the nozzles N is not considered.

In the above-described embodiment, the intermediate electrical potential of the fifth drive signal ComBa is set to the first electrical potential E1a which is the intermediate electrical potential of the first drive signal ComAa, but the present disclosure is not limited thereto. The intermediate electrical potential of the fifth drive signal ComBa may be set to an electrical potential different from the first electrical potential E1a which is the intermediate electrical potential of the first drive signal ComAa. As a result, the degree of freedom in designing the ejection pulse is further improved. In this case, the difference between the intermediate electrical potential of the fifth drive signal ComBa and the first electrical potential E1a, which is the intermediate electrical potential of the first drive signal ComAa, is preferably set in the same manner as the range Vx of change in the electrical potential described above. Furthermore, it is preferable that the time period of the fifth starting electrical potential-maintained element d1 be set to be equal to or close to the time period tx from the start of the first starting electrical potential-maintained element a1 to the intermediate point of the expansion element a2 of the first pulse PAa. In such a configuration, the fifth drive signal ComBa may correspond to a “second drive signal”. In this case, the fifth pulse PBa of the fifth drive signal ComBa corresponds to the “second pulse”, and the starting electrical potential of the fifth drive signal ComBa in a single driving cycle corresponds to a “second electrical potential”. Similarly, an intermediate electrical potential of the sixth drive signal ComBb may be set to an electrical potential different from the third electrical potential E1b which is the intermediate electrical potential of the third drive signal ComAb, and an intermediate electrical potential of the seventh drive signal ComBc may be set to an electrical potential different from the fourth electrical potential E1c which is the intermediate electrical potential of the fourth drive signal ComAc.

Each of the second head chips 51b in the present embodiment described above may correspond to a “first head chip”, and each of the first head chips 51a or each of the third head chips 51c may correspond to a “second head chip”. In this case, each of the second nozzles Nb, each of the second pressure chambers Cb, each of the second drive elements Eb, and each of the second ejection sections 510b correspond to a “first nozzle”, a “first pressure chamber”, a “first drive element”, and a “first ejection section”. Each of the first nozzles Na, each of the first pressure chambers Ca, each of the first drive elements Ea, and each of the first ejection sections 510a, or each of the third nozzles Nc, each of the third pressure chambers Cc, each of the third drive elements Ec, and each of the third ejection sections 510c correspond to a “second nozzle”, a “second pressure chamber”, a “second drive element”, and a “second ejection section”. Similarly, each of the third head chips 51c may correspond to the “first head chip”, and each of the first head chips 51a or each of the second head chips 51b may correspond to the “second head chip”. In this case, each of the third nozzles Nc, each of the third pressure chambers Cc, each of the third drive elements Ec, and each of the third ejection sections 510c correspond to the “first nozzle”, the “first pressure chamber”, the “first drive element”, and the “first ejection section”. Each of the first nozzles Na, each of the first pressure chambers Ca, each of the first drive elements Ea, and each of the first ejection sections 510a, or each of the second nozzles Nb, each of the second pressure chambers Cb, each of the second drive elements Eb, and each of the second ejection sections 510b correspond to the “second nozzle”, the “second pressure chamber”, the “second drive element”, and the “second ejection section”.

In the above-described embodiment, the liquid ejecting apparatus 100 is a line-type liquid ejecting apparatus in which the plurality of nozzles N are distributed over the entire width of the medium M, but the present disclosure is also applied to a serial-type liquid ejecting apparatus in which the carriage 501 in which the liquid ejecting head 50 is mounted reciprocates.

The liquid ejecting apparatus 100 described in the above-described embodiment may be used in not only an apparatus dedicated for printing but also various apparatuses such as a facsimile machine and a copy machine, and the application of the present disclosure is not particularly limited. However, the application of the liquid ejecting apparatus is not limited to printing. For example, a liquid ejecting apparatus that ejects a solution of a coloring material is used as a manufacturing apparatus that forms a color filter for a display device such as a liquid crystal display panel. In addition, a liquid ejecting apparatus that ejects a solution of a conductive material is used as a manufacturing apparatus that forms a wiring or an electrode for a wiring substrate. Furthermore, a liquid ejecting apparatus that ejects a solution of an organic substance related to a living body is used, for example, as a manufacturing apparatus that manufactures a biochip.

Although the present disclosure is described based on the preferred embodiments, the present disclosure is not limited to the above-described embodiments. The configuration of each section of the present disclosure can be replaced with any configuration that has the same function as that in the above-described embodiment, and any configuration can be added.

What is claimed is:

1. A liquid ejecting apparatus comprising:
a liquid ejecting head including a first ejection section including a first nozzle from which liquid is ejected, a first pressure chamber communicating with the first nozzle, and a first drive element that is configured to be driven to change a volume of the first pressure chamber in accordance with a drive signal;
a first drive signal generating circuit that is configured to generate a first drive signal having a first pulse to be supplied to the first drive element when a droplet in a first amount is to be ejected from the first nozzle; and
a second drive signal generating circuit that is configured to generate a second drive signal having a second pulse to be supplied to the first drive element and different from the first pulse, wherein
the first drive signal has a first starting electrical potential-maintained element that maintains a first electrical potential from start of a single driving cycle to start of the first pulse,
the second drive signal has a second starting electrical potential-maintained element that maintains a second electrical potential from the start of the single driving cycle to start of the second pulse, and
the first electrical potential is different from the second electrical potential.

2. The liquid ejecting apparatus according to claim 1, wherein
the first pulse has an expansion element that changes an electrical potential to drive the first drive element so as to increase a volume of the first pressure chamber, and an ejection element that changes the electrical potential after the expansion element to drive the first drive element so as to reduce the increased volume of the first pressure chamber such that a droplet in the first amount is ejected from the first nozzle,
a time period tx from start of the first starting electrical potential-maintained element to an intermediate point of the expansion element of the first pulse satisfies an inequality of 0.25×TC+n≤tx≤0.75×TC+n, and
TC is a natural vibration period of the first ejection section, and n is a natural number.

3. The liquid ejecting apparatus according to claim 1, wherein
a time period tx from start of the first starting electrical potential-maintained element to an intermediate point of the expansion element of the first pulse satisfies an equation of tx=0.5×TC+n, and
TC is a natural vibration period of the first ejection section, and n is a natural number.

4. The liquid ejecting apparatus according to claim 1, wherein the first drive signal has a first ending electrical potential-maintained element that maintains the first electrical potential from end of the first pulse to end of the single driving cycle.

5. The liquid ejecting apparatus according to claim 1, wherein a difference between the first electrical potential and the second electrical potential is less than or equal to 4.0 V.

6. The liquid ejecting apparatus according to claim 1, wherein a highest ejection frequency determined by the first drive signal and the second drive signal is higher than or equal to 10 KHz.

7. The liquid ejecting apparatus according to claim 1, further comprising:
an ejection amount information acquirer that is configured to acquire a first ejection amount information regarding an amount of a droplet to be ejected from the first nozzle; and
a controller that is configured to generate a first drive signal information specifying a waveform of the first drive signal based on the first ejection amount information and transmit the first drive signal to the first drive signal generating circuit, wherein
the first pulse has an expansion element that changes an electrical potential to drive the first drive element so as to increase a volume of the first pressure chamber, and an ejection element that changes the electrical potential after the expansion element to drive the first drive element so as to reduce the increased volume of the first pressure chamber such that a droplet in the first amount is ejected from the first nozzle, and
the controller generates the first drive signal information specifying a waveform of the first drive signal that is changed at least one of a range of change in the electrical potential of the expansion element of the first pulse, a range of change in the electrical potential of the ejection element of the first pulse, and the first electrical potential based on the first ejection amount information.

8. The liquid ejecting apparatus according to claim 1, wherein
the liquid ejecting head further includes a second ejection section including a second nozzle from which liquid is ejected, a second pressure chamber communicating with the second nozzle, and a second drive element that is configured to be driven to change a volume of the second pressure chamber in accordance with a drive signal,
the liquid ejecting apparatus further includes a third drive signal generating circuit that is configured to generate a third drive signal having a third pulse to be supplied to the second drive element when a droplet in the first amount is to be ejected from the second nozzle is provided,
the third drive signal has a third starting electrical potential-maintained element that maintains a third electrical potential from the start of the single driving cycle to start of the third pulse, and
the third electrical potential is different from at least the first electrical potential.

9. The liquid ejecting apparatus according to claim 8, wherein
the second pulse is a minute vibration pulse that is supplied to the first drive element when the liquid in the first nozzle is to be vibrated so as not to be ejected, and is supplied to the second drive element when the liquid in the second nozzle is to be vibrated so as not to be ejected,
the first drive signal is supplied to the first drive element without being supplied to the second drive element,
the third drive signal is supplied to the second drive element without being supplied to the first drive element, and
the second drive signal is supplied to the first drive element and the second drive element.

10. The liquid ejecting apparatus according to claim 8, wherein
the first pulse has an expansion element that changes an electrical potential to drive the first drive element so as to increase a volume of the first pressure chamber, and an ejection element that changes the electrical potential after the expansion element to drive the first drive element so as to reduce the increased volume of the first pressure chamber such that a droplet in the first amount is ejected from the first nozzle,
the third pulse has an expansion element that changes an electrical potential to drive the second drive element so as to increase the volume of the second pressure chamber, and an ejection element that changes the electrical potential after the expansion element to reduce the increased volume of the second pressure chamber such that a droplet in the first amount is ejected from the second nozzle,
a range of change in the electrical potential of the expansion element of the first pulse is different from a range of change in the electrical potential of the expansion element of the third pulse, and
a range of change in the electrical potential of the ejection element of the first pulse is different from a range of change in the electrical potential of the ejection element of the third pulse.

11. The liquid ejecting apparatus according to claim 8, wherein
a time period tx from start of the first starting electrical potential-maintained element to an intermediate point of the ejection element of the first pulse and a time period tx from start of the third starting electrical potential-maintained element to an intermediate point of the ejection element of the third pulse satisfy an inequality of 0.25×TC+n≤tx≤0.75×TC+n, and
TC is a natural vibration period of the second ejection section, and n is a natural number.

12. The liquid ejecting apparatus according to claim 8, wherein
a time period tx from start of the first starting electrical potential-maintained element to an intermediate point of the ejection element of the first pulse and a time period tx from start of the third starting electrical potential-maintained element to an intermediate point of the ejection element of the third pulse satisfy an equation of tx=0.5×TC+n, and
TC is a natural vibration period of the second ejection section, and n is a natural number.

13. The liquid ejecting apparatus according to claim 8, wherein
the first drive signal has a first ending electrical potential-maintained element that maintains the first electrical potential from end of the first pulse to end of the single driving cycle, and
the third drive signal has a third ending electrical potential-maintained element that maintains the third electrical potential from end of the third pulse to the end of the single driving cycle.

14. The liquid ejecting apparatus according to claim 8, wherein
a difference between the first electrical potential and the second electrical potential is less than or equal to 4.0 V, and
a difference between the second electrical potential and the third electrical potential is less than or equal to 4.0 V.

15. The liquid ejecting apparatus according to claim 8, wherein the second electrical potential is within a range from the first electrical potential to the third electrical potential.

16. The liquid ejecting apparatus according to claim 8, further comprising:
an ejection amount information acquirer that is configured to acquire a first ejection amount information regarding an amount of a droplet to be ejected from the first nozzle and a second ejection amount information regarding an amount of a droplet to be ejected from the second nozzle, and
a controller that is configured to generate a first drive signal information specifying a waveform of the first drive signal based on the first ejection amount information, generate a second drive signal information specifying a waveform of the second drive signal based on the second ejection amount information, transmit the first drive signal information to the first drive signal generating circuit and transmit the second drive signal information to the third drive signal generating circuit, wherein
the first pulse has an expansion element that changes an electrical potential to drive the first drive element so as to increase a volume of the first pressure chamber, and an ejection element that changes the electrical potential to reduce the increased volume of the first pressure chamber such that a droplet is ejected from the first nozzle,
the third pulse has an expansion element that changes an electrical potential to drive the second drive element so as to increase a volume of the second pressure chamber, and an ejection element that changes the electrical potential to reduce the increased volume of the second pressure chamber such that a droplet is ejected from the second nozzle,
the controller changes a range of change in the electrical potential of the expansion element of the first pulse, a range of change in the electrical potential of the ejection element of the first pulse, and the first potential based on the first ejection amount information, and
the controller changes a range of change in the electrical potential of the expansion element of the third pulse, a range of change in the electrical potential of the ejection element of the third pulse, and the third electrical potential based on the second ejection amount information.

17. A method of driving a liquid ejecting apparatus including a liquid ejecting head including a first ejection section including a first nozzle from which liquid is ejected, a first pressure chamber communicating with the first nozzle, and a first drive element that is configured to be driven to change a volume of the first pressure chamber in accordance with a drive signal, the method comprising:
generating a first drive signal having a first pulse to be supplied to the first drive element when a droplet in a first amount is to be ejected from the first nozzle; and
generating a second drive signal having a second pulse to be supplied to the first drive element and different from the first pulse, wherein
in the generation of the first drive signal and the second drive signal, a first electrical potential of a first starting electrical potential-maintained element which is included in the first drive signal and is from start of a single driving cycle to start of the first pulse is set to be different from a second electrical potential of a second starting electrical potential-maintained element which is included in the second drive signal and is from the start of the single driving cycle to start of the second pulse.
